(19) United States
(12) Patent Application Publication
(10) Pub. No.: US 2024/0397949 A1
(43) Pub. Date: Dec. 5, 2024

(54) POWDER PEST CONTROL COMPOSITIONS AND METHODS OF USING

(71) Applicant: Control Solutions, Inc., Pasadena, TX (US)

(72) Inventors: John Carespodi, Deer Park, TX (US); Janis Johnson Reed, Bryan, TX (US); Marie Ann Knox, Houston, TX (US); Ron Richardson, Ellisville, MO (US)

(73) Assignee: Control Solutions, Inc., Pasadena, TX (US)

(21) Appl. No.: 18/798,533

(22) Filed: Aug. 8, 2024

Related U.S. Application Data
(62) Division of application No. 17/491,491, filed on Sep. 30, 2021.
(60) Provisional application No. 63/085,633, filed on Sep. 30, 2020.

(51) Int. Cl. A01N 43/88; A01N 25/00; A01N 25/12; A01N 39/00; A01N 43/16; A01N 43/36; A01N 43/40; A01N 43/56; A01N 43/90; A01N 47/02; A01N 47/30; A01N 47/34; A01N 47/38; A01N 63/10; A01N 63/32; A01N 65/44; A01P 7/04; A01P 19/00

(52) U.S. Cl. CPC A01N 43/88; A01N 25/006; A01N 25/12; A01N 39/00; A01N 43/16; A01N 43/36; A01N 43/40; A01N 43/56; A01N 43/90; A01N 47/02; A01N 47/30; A01N 47/34; A01N 47/38; A01N 63/10; A01N 63/32; A01N 65/44; A01P 7/04; A01P 19/00

(57) ABSTRACT

Compositions and methods for controlling pests are disclosed. The compositions can be electrostatically charged, can be attractive for translocation by the social insects into nesting, tunneling, and/or gathering structures of the social insects, or both. Kits comprising the compositions and a powder delivery device operable to electrostatically charge a pest control composition during delivery are also disclosed.

### CROSS-REFERENCE TO RELATED APPLICATION

This application is a divisional of U.S. patent application Ser. No. 17/491,491 filed Sep. 30, 2021 and claims the benefit of U.S. Provisional Application No. 63/085,633, filed Sep. 30, 2020, the disclosure of which is hereby expressly incorporated by reference herein in its entirety.

### FIELD OF THE INVENTION

The present disclosure provides electrostatically charged pesticidal compositions, and/or pesticidal compositions attractive for translocation by social insects into nesting, tunneling, and/or gathering structures of the social insects. Methods of using the compositions are also disclosed.

### BACKGROUND OF THE INVENTION

Arthropods such as termites, carpenter ants, fire ants and roaches have been a common nuisance pest. In southern regions, especially Florida, termites are considered to be one of the most destructive arthropod pests for structures. Blattella germanica (the German cockroach) and Periplaneta americana (the American cockroach) are ubiquitous throughout the world. They are the major insect pests in residences, restaurants, hospitals, dormitories and warehouses. Cockroaches are unsightly and have been implicated as vectors of several human disease agents. For these and other reasons, there is a continuing need to provide effective pesticidal control in a home or business while avoiding concentrations of insecticides that might be harmful to humans or other animals.

### SUMMARY OF THE INVENTION

One aspect of the present disclosure encompasses a pesticidal powder composition for controlling a target pest. The composition comprises one or more pesticidal ingredient; one or more anticaking agent; optionally one or more environmentally mimicking agent; and optionally one or more attractant. The composition is electrostatically charged on application. The composition can be electrostatically charged during application using a device capable of electrostatically charging the composition during application. The device can be operable to deliver the composition via pressurized air columns. The pest can be an insect pest.

The pest can be termites. When the pest is termites, the electrostatically charged composition can comprise one or more pesticidal ingredient, one or more anticaking agent, and one or more environmentally mimicking agent. The pest can also be a roach. When the pest is a roach, the electrostatically charged composition can comprise one or more pesticidal ingredient, one or more anticaking agent, and one or more food source. When the pest is a roach, the electrostatically charged composition can also comprise one or more pesticidal ingredient, one or more anticaking agent, one or more environmentally mimicking agent, and one or more food source.

The size of particles can be about 125 μm or less. The moisture content ranges from about 2% to about 5% w/w. The composition can be delayed acting.

Another aspect of the present disclosure encompasses a non-consumable pesticidal powder composition for precise application into nesting, tunneling, and/or gathering structures of social pests to control a target social insect. The composition comprises one or more pesticidal ingredient; one or more anticaking agent; optionally one or more environmentally mimicking agent; and optionally one or more attractant. The composition is attractive for translocation by the social insects into nesting, tunneling, and/or gathering structures of the social insects. The composition can be delayed acting.

The composition can be electrostatically charged during application using a device capable of electrostatically charging the composition during application. The device can be operable to deliver the composition via pressurized air columns. The pest can be an insect pest.

The pest can be termites. When the pest is termites, the non-consumable pesticidal powder composition comprises one or more pesticidal ingredient, one or more anticaking agent, and one or more environmentally mimicking agent. The pest can also be a roach. When the pest is a roach, the non-consumable pesticidal powder composition can comprise one or more pesticidal ingredient, one or more anticaking agent, and one or more environmentally mimicking agent.

Another aspect of the present disclosure encompasses a pesticidal powder composition for controlling a target pest. The composition comprises novaluron at a concentration ranging from about 0.15% to about 0.25% w/w; precipitated calcium carbonate at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w. The composition is electrostatically charged on application. The corn grit can be 100 mesh or less.

Another aspect of the present disclosure encompasses a pesticidal powder composition for controlling a target pest. The composition comprises novaluron at a concentration ranging from about 0.15% to about 0.25% w/w; precipitated calcium carbonate at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w. The composition is electrostatically charged on application. The corn grit can be 100 mesh or less.

Another aspect of the present disclosure encompasses a pesticidal powder composition for controlling a target pest. The composition comprises indoxacarb at a concentration ranging from about 0.7% to about 1% w/w; novaluron at a concentration ranging from about 0.15% to about 0.25% w/w; pyriproxyfen at a concentration ranging from about 0.15% to about 0.25% w/w; fumed silica at a concentration ranging from about 0.8% to about 1.2% w/w; and brewer's yeast at a concentration ranging from about 95% to about 99.9% w/w. The composition is electrostatically charged on application. The composition can further comprise about 3% to about 7% w/w attapulgite.

Yet another aspect of the present disclosure encompasses pesticidal powder compositions comprising indoxacarb at a concentration ranging from about 0.1% to about 5% w/w, from about 0.5% to about 1.5% w/w, or from about 0.7% to about 1% w/w; fumed silica at a concentration ranging from about 0.1% to about 10% w/w of from about 0.5% to about 8% w/w, or from about 0.8% to about 1.2% w/w; and brewer's yeast at a concentration ranging from about 95% to about 99.9% w/w. The composition is electrostatically charged on application. The composition can further comprise about 3% to about 7% w/w attapulgite.

Yet another aspect of the present disclosure encompasses a pesticidal powder composition comprising chlorfenapyr at a concentration ranging from about 0.001% to about 1% w/w, from about 0.01% to about 0.1% w/w, or from about 0.03% to about 0.07% w/w; confectioner's sugar at a concentration ranging from about 10% to about 80% w/w, from about 20% to about 70% w/w, from about 30% to about 60% w/w, or from about 40% to about 55% w/w; fumed silica at a concentration ranging from about 0.1% to about 10% w/w of from about 0.5% to about 8% w/w, or from about 0.8% to about 1.2% w/w, and powdered kidney at a concentration ranging from about 10% to about 80% w/w, from about 20% to about 70% w/w, from about 30% to about 60% w/w, or from about 40% to about 55% w/w. The composition is electrostatically charged on application. The composition can further comprise about 3% to about 7% w/w attapulgite.

One aspect of the present disclosure encompasses a pesticidal powder composition comprising indoxacarb at a concentration ranging from about 0.01% to about 0.5% w/w, from about 0.05% to about 0.1% w/w, or from about 0.06% to about 0.9% w/w; confectioner's sugar at a concentration ranging from about 10 to about 80% w/w, from about 20% to about 70% w/w, from about 30% to about 60% w/w, or from about 40% to about 55% w/w; fumed silica at a concentration ranging from about 0.1% to about 10% w/w, from about 0.5% to about 8% w/w, or from about 0.8% to about 1.2% w/w; and powdered kidney at a concentration ranging from about 10% to about 80% w/w, from about 20% to about 70% w/w, from about 30% to about 60% w/w, or from about 40% to about 55% w/w. The composition is electrostatically charged on application. The composition can further comprise about 3% to about 7% w/w attapulgite.

Another aspect of the present disclosure encompasses a pesticidal powder composition comprising indoxacarb at a concentration ranging from about 0.01% to about 0.5% w/w, from about 0.05% to about 0.1% w/w, or from about 0.06% to about 0.9% w/w; novaluron at a concentration ranging from about 0.005% to about 0.1% w/w, from about 0.01% to about 0.15% w/w, or from about 0.015% to about 0.025% w/w; pyriproxyfen at a concentration ranging from about 0.005% to about 0.1% w/w, from about 0.01% to about 0.15% w/w, or from about 0.015% to about 0.025% w/w; fumed silica at a concentration ranging from about 0.1% to about 10% w/w, from about 0.5% to about 8% w/w, or from about 0.8% to about 1.2% w/w; whey protein isolates at a concentration ranging from about 10% to about 80% w/w, from about 20% to about 70% w/w, from about 30% to about 60% w/w, or from about 40% to about 55% w/w; confectioner's sugar at a concentration ranging from about 10% to about 80% w/w, from about 20% to about 70% w/w, from about 30% to about 60% w/w, or from about 40% to about 55% w/w; and brewer's yeast at a concentration ranging from about 5% to about 30% w/w, from about 10% to about 20% w/w, or from about 13% to about 17% w/w. The composition is electrostatically charged on application. The composition can further comprise about 3% to about 7% w/w attapulgite.

Another aspect of the present disclosure encompasses a non-consumable pesticidal powder composition for control of social insects. The composition comprises fipronil at a concentration ranging from about 0.1% to about 1% w/w or from about 0.3% to about 0.7% w/w; precipitated calcium carbonate at a concentration ranging from about 0.1% to about 10% w/w, or from about 0.8% to about 1.2% w/w; 2-phenoxy ethanol at a concentration ranging from about 0.01% to about 1% w/w, from about 0.05% to 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. The corn grit can be 100 mesh or less.

Yet another aspect of the present disclosure encompasses a non-consumable pesticidal powder composition for control of social insects. The composition comprises novaluron at a concentration ranging from about 0.05% to about 1% w/w, from about 0.1% to about 1.5% w/w, or from about 0.15% to about 0.25% w/w; precipitated calcium carbonate at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. The corn grit can be 100 mesh or less.

Another aspect of the present disclosure encompasses a non-consumable pesticidal powder composition for control of social insects. The composition comprises fipronil at a concentration ranging from about 0.01% to about 1% w/w, from about 0.05% to about 0.5% w/w, or from about 0.08% to about 1.2% w/w; imidacloprid at a concentration ranging from about 0.001% to about 10% w/w, from about 0.1% to about 1% w/w, or from about 0.3% to about 0.7% w/w; powdered cellulose at a concentration ranging from about 0.001 to about 10% w/w, from about 0.1% to about 1% w/w, or from about 0.3% to about 0.7% w/w; precipitated calcium carbonate at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and attapulgite at a concentration ranging from about 95% to about 99.9% w/w. The composition is attractive for translocation by the social insects into nesting, tunneling, and/or gathering structures of the social insects. The attapulgite can be 100 mesh or less.

One aspect of the present disclosure encompasses a non-consumable pesticidal powder composition for control of social insects. The composition comprises chlorfenapyr at a concentration ranging from about 0.01% to about 10% w/w, from about 0.1% to about 1% w/w, or from about 0.4% to about 0.8% w/w; tricalcium phosphate powder at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. The corn grit can be 100 mesh or less.

One aspect of the present disclosure encompasses a non-consumable pesticidal powder composition for control of social insects. The composition comprises indoxacarb at a concentration ranging from about 0.1% to about 5% w/w, from about 0.5% to about 1.5% w/w, or from about 0.7% to about 1% w/w; novaluron at a concentration ranging from about 0.05% to about 1% w/w, from about 0.1% to about 1.5% w/w, or from about 0.15% to about 0.25% w/w; pyriproxyfen at a concentration ranging from about 0.05% to about 1% w/w, from about 0.1% to about 1.5% w/w, or from about 0.15% to about 0.25% w/w; ergosterol at a concentration ranging from about 0.01% to about 1% w/w, from about 0.05% to about 0.75% w/w, or from about 0.08% to about 0.12% w/w; stearic acid at a concentration ranging from about 0.2% to about 20% w/w, from about 1% to about 15% w/w, or from about 1.5% to about 2.5% w/w; bentonite at a concentration ranging from about 0.2% to about 20% w/w, from about 1% to about 15% w/w, or from about 1.5% to about 2.5% w/w; powdered chitin at a concentration ranging from about 1% to about 40% w/w, from about 5% to about 20% w/w, or from about 8% to about 12% w/w; and powdered kaolin at a concentration ranging from about 10% to about 95% w/w, from about 50% to about 90% w/w, or from about 75% to about 90% w/w. The composition is attractive for translocation by the social insects into nesting, tunneling, and/or gathering structures of the social insects. The bentonite can be 200 mesh or finer bentonite, the powdered chitin can be 100 mesh or finer chitin, and the powdered kaolin can be 100 mesh or finer kaolin.

Another aspect of the present disclosure encompasses a method of controlling a pest. The method comprising applying to a site where control is sought a pesticidally effective amount of a pesticidal powder composition, wherein the composition is the composition of any one of claims 1-54.

### BRIEF DESCRIPTION OF THE FIGURES

FIG. 1 are photographs of the thin plate arenas showing the outworld where termites are introduced (first panel), the treatment of void space (second panel), and the treatment arena 24 hours after treatment (third panel).

FIG. 2 is a photograph of a test arena used for testing dry flowable bait formulas against mixed populations of German cockroaches.

FIG. 3 is a photograph of a test arena used for testing dry flowable bait formulas against mixed populations of German cockroaches.

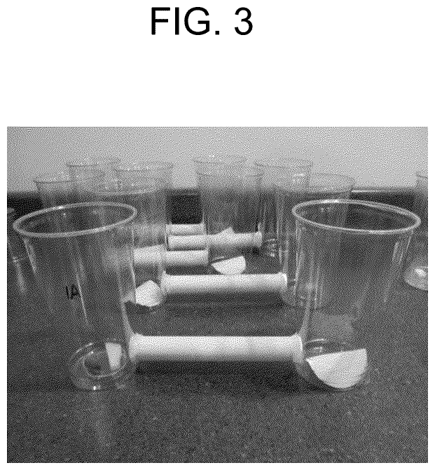

FIG. 4 are photographs of test systems in the test arena of FIG. 3.

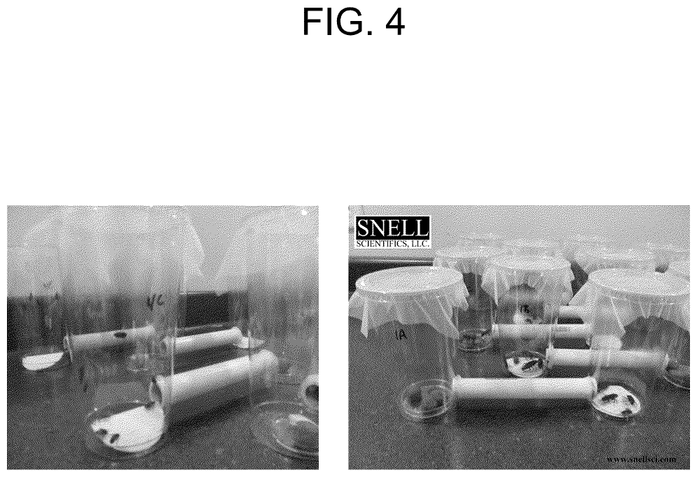

FIG. 5 are photographs of dead test systems in the test arena of FIG. 3.

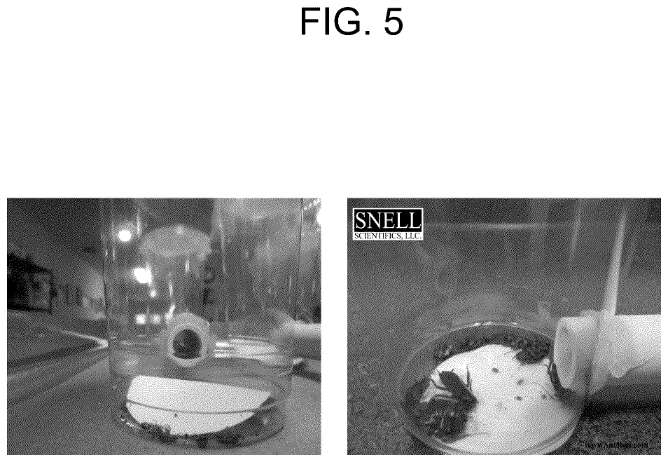

FIG. 6 is a photograph of an arena used in this experiment. Shown is a dish with the laboratory diet (dog food), a dish with 0.15 g of Doxem dust bait, and a source of harborage. A water source was also made available and replenished as needed.

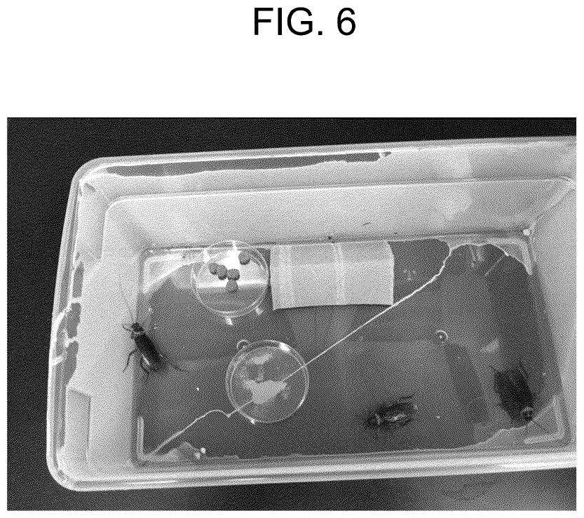

FIG. 7 is a plot showing of the percentage of bait consumed per species. Numbers followed by different letters were significantly different (ANOVA with Tukey's, p<0.05).

FIG. 8 is a graph of mortality of American cockroaches over time.

FIG. 9 is a graph of mortality of oriental cockroaches over time.

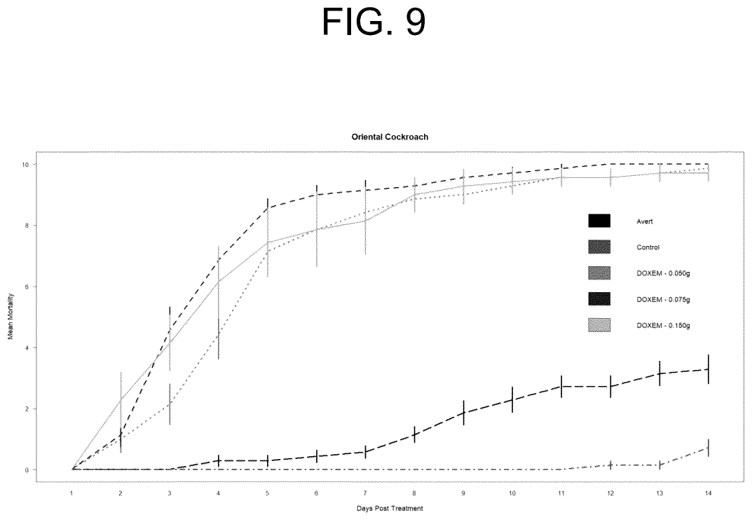

FIG. 10 is a graph of mortality of German cockroaches over time.

FIG. 11 is a photograph of the composition after wetting and drying.

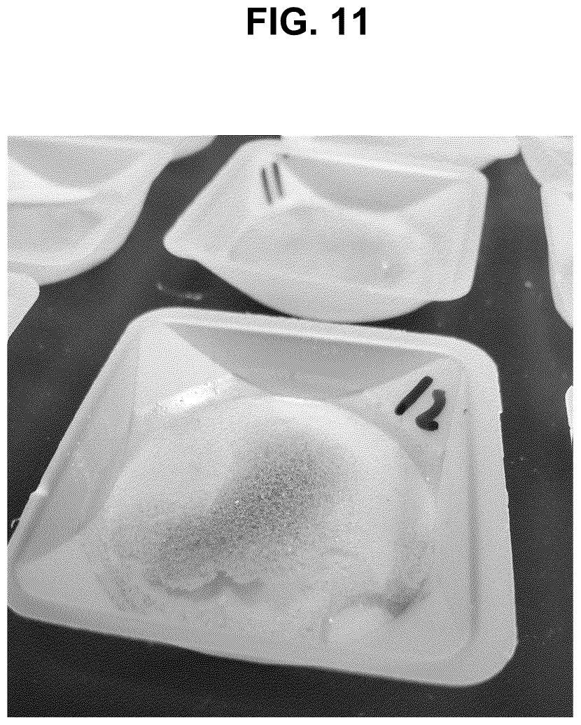

### DETAILED DESCRIPTION

The present disclosure is based in part on the discovery of dry flowable pesticidal powder compositions and methods of using the compositions to control populations of pests. The compositions can be electrostatically charged, can be attractive for translocation by the social insects into nesting, tunneling, and/or gathering structures of the social insects, or both. The compositions and methods of using the compositions are described further below.

### I. Compositions

One aspect of the present disclosure encompasses dry flowable pesticidal powder compositions for application in the environment of a target pest to be controlled. The pest can be an insect or a member of the arachnid subclass Acari, which includes ticks and mites. The compositions comprise one or more pesticidal ingredient, one or more anticaking agent, and optionally one or more environmentally mimicking agent (mimicking agent). The compositions can also comprise one or more attractant.

In some aspects, the compositions are electrostatically charged during application. The electrostatic charge firmly adheres the composition to the external cuticle of a pest. In some alternatives of the aspects, the electrostatically charged composition comprises one or more pesticidal ingredient, one or more anticaking agent, and one or more attractant. In some aspects, the attractant is a food source. For instance, the composition can be used as bait having the food source as the attractant. In one aspect, the pest is a roach, and the electrostatically charged composition comprises one or more pesticidal ingredient, one or more anticaking agent, and one or more food source.

In other aspects, the compositions are non-consumable powder compositions attractive for translocation by the social insects into nesting, tunneling, and/or gathering structures of the social insects. As used herein, the term “non-consumable” refers to a composition of the instant disclosure, wherein none of the ingredients of the composition is intended to be consumed, or intended as a food source by the pest when included in the composition. Put another way, a non-consumable composition is not a bait composition intended to be consumed by the pest. For instance, when a composition comprises an attractant for the pest, the attractant is a non-food attractant and can be as described in Section I(d) herein below.

In some aspects, the composition is electrostatically charged on application and is a non-consumable composition attractive for translocation by the social insects into nesting, tunneling, and/or gathering structures of the social insects. In one aspect, the pest is termites, and the electrostatically charged composition comprises one or more pesticidal ingredient, one or more anticaking agent, and one or more environmentally mimicking agent.

The compositions can maintain their flowable powder form for a period of time sufficient for the compositions to effectively control the pest after application. As such, the compositions are non-hydrophilic and non-caking. In some aspects, the moisture content of the composition ranges from about 0.1% to about 10% w/w, or from about 2% to about 5% w/w.

Further, the size of each particle in the powder composition is of a size sufficient to promote dispersability of the composition in the environment of the organism, and to remain appealing to target organisms, allowing for translocation by animal behavior into colonial groups. In some aspects, the size of each particle in the powder composition is about 125 μm or less, about 100 μm or less, or ranges from about 50 to about 100 μm.

Depending on the pest to be controlled, the compositions can have a fast or delayed pesticidal effect on the organism. For instance, control of a solitary pest can be more effective if the composition is a fast acting composition, killing the organism on contact. Conversely, when the pest is a social insect such as a termite, a delayed acting pesticidal composition can provide sufficient time for horizontal transfer of the composition throughout the termite colony. Similarly, a delayed acting pesticidal composition can provide sufficient time for transferring the composition to other roaches in the treated area. Delayed acting pesticidal effect can be achieved using pesticides having sufficient activity latency to facilitate translocation of insects from placement and/or to limit behavioral avoidance. In some aspects, the pest is termites, and the composition is delayed acting.

The compositions can mimic the natural environment of a target pest, or otherwise be attractive to target organisms. For instance, the compositions can be attractive to pests as, e.g., a food source in bait compositions or as a building material. For example, when the target pest is termites, the composition can comprise powdered cellulosic material, and the building material powdered cellulosic material or powdered clays which can mimic a food source and building material. Alternatively or additionally, the compositions can be attractive to pests for comprising a chemical attractant that compels the pest to seek the composition.

Alternatively, the compositions can be neutral to the behavior of the pest. As used herein, the term “neutral” is used to describe a composition that is neither attractant to, nor edible by the pest. Neutral compositions are not repellent, limit behavioral avoidance, and can be applied in the environment of the organism without affecting the behavior of the organism. Delayed acting pesticidal effect can be achieved using pesticides having sufficient activity latency to facilitate translocation of insects. Additionally or alternatively, a delayed pesticidal effect can be achieved by application of an amount of pesticide that allows for delayed activity of the pesticide.

The various components of the composition are described below. It will be recognized that one or more of the components can exhibit more than one characteristic of the ingredients of the composition. For instance, when a composition of the disclosure comprises a clay ingredient, the clay can be an anticaking agent used to maintain the flowability of the composition and as an environmentally mimicking agent for use as a building material by, e.g., termites.

### (a) Pesticidal Ingredient

The composition comprises one or more pesticide. Pesticides are defined as chemicals used to kill pests. Pesticides include insecticides and acaricides. The pesticides can be ingestion-active or systemic pesticides. Alternatively, the pesticides can be contact pesticides. Pesticides can be ovicides or substances that kill eggs, larvicides or substances that kill larvae, or adulticides or substances that kill adult insects. Several types of pesticides are described in more detail below.

Irrespective of the type of pesticide, the pesticide and the concentration of the pesticide must be appropriate for the desired activity of the composition. For instance, when a composition is a delayed acting composition for translocation into a colony or to be shared among pests in the environment of the pest, the type and amount of pesticides in the composition must allow sufficient activity latency to facilitate translocation of the composition to other pests. Delayed activity can be inherent to the pesticide. Alternatively, the delayed activity can be controlled by the concentration of the pesticide in the composition. As such, the concentration of a pesticide in a composition of the disclosure can and will vary depending on the pesticide, the target pest among others, and can be determined experimentally for each pesticide.

### A. Insecticides

An insecticide is a pesticide used against insects in all developmental forms. Insecticides are commonly used in agriculture, medicine, industry, and for household use. Representative insecticides useful in the present invention include pyrethrum type insecticides, such as pyrethrin; pyrethroids, such as deltamethrin, permethrin, β-cyfluthrin, bifenthrin, and resmethrin; nicotinics, particularly chloronicotinyl compounds, such as acetamiprid, imidacloprid, thiamethoxam, clothianidin, acetamiprid, thiacloprid, and dinotefuran; pyrazoles such as fipronil, ethiprole, and tebufenpyrad; semicarbazones such as indoxacarb and metaflumizone, phthalic acid diamides such as flubendiamide and (S)-3-chloro-N1-{2-methyl-4-[1,2,2,2-tetrafluoro-1-(trifluoromethyl)ethyl]phenyl}-N2-(1-methyl-2-methylsulfonylethyl)phthalamide; anthranilic acid amides such as chloroanthraniliprole; organophosphates such as chlorpyrifos, malathion, and diazinon; carbamates such as bendiocarb, carbaryl, and thiodicarb; ketoenoles such as spirotetramat, spirodiclofen, and spiromesifen; phthalic acid diamides such as insecticides with an active ingredients from the anthranilic diamide class such as that sold by DuPont under the tradename Rynaxypyr (hereinafter referred to a rynaxypyr for ease of reference), and flubendiamide; IGRs such as methoprene, pyriproxifen, triflumuron, hexaflumuron, noviflumuron, fenoxycarb; and other insecticides, such as abamectin, hydramethylnon, sulfluramid, and spinosad. Representative chlorinated hydrocarbons include aldrin, chlordane, chlordecone, DDT, dieldrin, endosulfan, endrin, heptachlor, hexachlorocyclohexane, gamma-hexachlorocyclohexane, lindane, methoxychlor, mirex, pentachlorophenol, and TDE. Representative organophosphorus insecticides include acephate, azinphos-methyl, bensulide, chlorethoxyfos, chlorpyrifos, chlorpyriphos-methylm diazinon, dichlorvos (DDVP), dicrotophos, dimethoate, disulfoton, ethoprop, fenamiphos, fenitrothion, fenthion, fosthiazate, malathion, methamidophos, methidathion, methyl-parathion, mevinphos, naled, omethoate, oxydemeton-methyl, parathion, phorate, phosalone, phosmet, phostebupirim, pirimiphos-methyl, profenofos, terbufos, tetrachlorvinphos, tribufos, trichlorfon. Representative carbamates include aldicarb, carbofuran, carbaryl, methomyl, and 2-(1-methylpropyl)phenyl methylcarbamate. Representative pyrethroids include allethrin, beta-cyfluthrin, bifenthrin, cyfluthrin, deltamethrin, permethrin, resmethrin, sumithrin, tetramethrin, tralomethrin, and transfluthrin. Representative plant toxin derived insecticides include derris (rotenone), pyrethrum, neem (azadirachtin), nicotine, caffeine, and compositions thereof.

Additional insecticides include cyclic ketoenols with insecticidal and acaricidal properties, such as those described in EP 528 156 A, WO 95/01971, EP 647 637 A, WO 96/16061, WO 96/20196, WO 96/25395, WO 96/35664, WO 97/02243, WO 97/01535, WO 97/36868, WO 97/43275, WO 98/05638, WO 98/06721, WO 99/16748, WO 99/43649, WO 99/48869, and WO 99/55673, each hereby incorporated by reference with regard to such teaching.

Certain pesticides are exempt from the requirements of the FIFRA act (40 CFR 152.25(f)). They are commonly known as minimum risk pesticides. Examples of these pesticides includes castor oil (U.S.P. or equivalent), cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemongrass oil, linseed oil, malic acid, mint and mint oil, peppermint and peppermint oil, 2-phenethyl propionate (2-phenylethyl propionate), potassium sorbate, putrescent whole egg solids, rosemary and rosemary oil, sesame (includes ground sesame plant) and sesame oil, sodium chloride (table salt), sodium lauryl sulfate, soybean oil, thyme and thyme oil, and white pepper.

Numerous heterocycles, organotin compounds, benzoylureas and pyrethroids have insecticidal and acaricidal properties, for example, see WO 93/22297, WO 93/10083, DE 2 641 343 A, EP 347 488 A, EP 210 487 A, U.S. Pat. No. 3,264,177, and EP 234 045 A, each herein incorporated by reference with regard to such teaching.

Certain bacteria, fungi, and other biological material may be active as insecticides. When these biological insecticides are inactive against other organisms, some are considered more environmentally friendly than synthetic pesticides. Examples include, but are not limited to, Bacillus sphericus, Bacillus subtilis, Bacillus cereus, or combinations of such material.

In some aspects, the pesticide is abamectin, acetamiprid, borax (sodium tetraborate), boric acid, boron sodium oxide, chlorantranaliprole, cyantranaliprole, chlorfenapyr, copper ammonium carbonate, copper carbonate, basic, copper hydroxide, copper quinolate, cupric oxide, diflubenzuron, dinotefuran, fipronil, hexaflumuron, hydramethylnon, imidacloprid, indoxacarb, novaluron, noviflumuron, pyriproxyfen, sodium borate pentahydrate, tebuconazole, thiamethoxam, or combinations thereof. In some aspects, the pesticide is fipronil, indoxacarb, novaluron, pyriproxyfen, chlorfenapyr, or combinations thereof.

### B. Acaricides

Any suitable acaracide can be used. Examples of suitable acaricides include sumiito (2-tert-butyl-5-(4-tert-butylbenzylthio)-4-chloropyridazine-3-(2H)-one), acricid (2,4-dinitro-6-sec-butylphenyldimethylacrylate), chloromite (isopropyl 4,4-dichlorobenzylate), Akar (ethyl 4,4′-dichlorobenzilate), kelthane (2,2,2trichloro-1,1-bis(p-chlorophenyl)-ethanol), citrazon (benzoic 3-chloro-N-ethoxy-2,6-dimethoxybenzimidic anhydride), omite (2-(p-tert-butylphenoxy)cyclohexyl propyn-2-yl sulfite), osadan (bis[tris(2-methyl-2-phenylpropyl)tin]oxide), hexythiazox (trans-5-(4-chlorophenyl)-N-cyclohexyl-4-methyl-2-oxothiazol-idine-3-carboxamide), and amitraz (N,N-bis(2,4-xylyliminomethyl)methylamine).

### (b) Anticaking Agent

The compositions comprise one or more anticaking agent. As used herein, the term “anticaking agent” is an additive placed in powdered or granulated materials to prevent the formation of lumps (caking) and for easing packaging, transport, and flowability. Caking mechanisms depend on the nature of the material. Crystalline solids often cake by formation of liquid bridge and subsequent fusion of microcrystals. Amorphous materials can cake by glass transitions and changes in viscosity. Polymorphic phase transitions can also induce caking. The most widely used anticaking agents include the stearates of calcium and magnesium, silica and various silicates, talc, as well as flour and starch. Non-limiting examples of anticaking agents include tricalcium phosphate, powdered cellulose, magnesium stearate, sodium bicarbonate, sodium ferrocyanide, potassium ferrocyanide, calcium ferrocyanide, bone phosphate (i.e. Calcium phosphate), sodium silicate, silicon dioxide, calcium silicate, magnesium trisilicate, talcum powder, sodium aluminosilicate, potassium aluminium silicate, calcium aluminosilicate, bentonite, aluminium silicate, stearic acid, and polydimethylsiloxane.

In some aspects, the anticaking agent is fluorapatite, calcium carbonate, sodium bicarbonate, tricalcium phosphate, bentonite, powdered cellulose, magnesium carbonate, solid polydimethylsiloxanes, titanium dioxide, graphite powders, or combinations thereof. In some aspects, the anticaking agent is silica, fumed silica, calcium carbonate, magnesium carbonate, solid polydimethylsiloxanes, aluminosilicates, or combinations thereof.

### (c) Environmentally Mimicking Agent

The compositions comprise one or more environmentally mimicking agent. As used herein, the term “environmentally mimicking agent” can be any powder ingredient that mimics, or is compatible with the environment of a pest. The environmentally mimicking agent can be an edible ingredient. The environmentally mimicking agent can also be a building material. Additionally, the environmentally mimicking ingredient can mimic material normally found in the environment of the organism without necessarily being of use to the pest as food or building material. When the composition is a delayed acting composition, the environmentally mimicking agent is non-toxic, non-hydrophilic, and prevents desiccation and cuticle shredding exhibited by other, industrially common, environmentally mimicking agents such as carboxylated cellulose.

Non-limiting examples of suitable environmentally mimicking agent include powdered cellulosic materials, powdered clays including powdered attapulgite, powdered bentonite, powdered chitinous materials, powdered montmorillonite, powdered kaolinite, powdered vermiculite, powdered dolomite, calcium silicates, aluminum silicates, and combinations thereof.

### (d) Attractant

The term “attractant,” as employed herein, refers to any substance which a pest will find appealing as a food item such that it will tend to transport it back to the nest and expressly includes foods, baits, attractants and feeding stimulants, as well as combinations thereof.

Any ingredient capable of attracting a desired pest can be used in a composition of the instant disclosure provided the ingredient possesses the suitable characteristics essential for this invention. In some aspects, the ingredient is of a certain size, is hygroscopic, etc.

Suitable ingredients can be an ingredient perceived as a food by the pest. The food attractant can and will vary depending on the pest, the method of using the composition, and the intended use of the composition. For instance, when the pest is termites, non-limiting examples of a food attractant can be brown rot derivatives, scorched cellulosic material, edible fungus derivatives, long-chain fatty acids. When the pest is roaches, non-limiting examples of a food attractant can be brewer's yeast, distiller's dried grain with or without solubles including as corn distiller's dried grain, sugar, gelatin, powdered organ meats, powdered cheese, brown rot derivatives, scorched cellulosic material, edible fungus derivatives, long-chain fatty acids. In some aspects, the food attractant is brewer's yeast. In some aspects, the food attractant is distiller's dried grain. In some aspects, the food attractant is corn distiller's dried grain with solubles.

Alternatively, the attractant can be a non-food (also referred to herein as non-edible or non-consumable) attractant. For instance, a suitable attractant can be semiochemicals that mimic pest attraction systems found in nature. Non-limiting examples of semiochemicals include pheromones, plant volatiles, flower oils, sugars and proteins. Pheromones can be as described below.

### A. Aggregation Pheromone

Aggregation pheromones function in mate selection, overcoming host resistance by mass attack, and defense against predators. A group of individuals at one location is referred to as an aggregation, whether consisting of one sex or both sexes. Male-produced sex attractants have been called aggregation pheromones, because they usually result in the arrival of both sexes at a calling site and increase the density of conspecifics surrounding the pheromone source. Most sex pheromones are produced by the females; only a small percentage of sex attractants are produced by males.[6] Aggregation pheromones have been found in members of the Coleoptera, Diptera, Hemiptera, Dictyoptera, and Orthoptera.

### B. Alarm Pheromones

Some species of pests release a volatile substance when attacked by a predator that can trigger flight (in aphids) or aggression (in ants, bees, termites) in members of the same species. For example, Vespula squamosa use alarm pheromones to alert others to a threat. In Polistes exclamans, alarm pheromones are also used as an alert to incoming predators.

### C. Epideictic

Epideictic pheromones are different from territory pheromones, when it comes to insects. Fabre observed and noted how “females who lay their eggs in these fruits deposit these mysterious substances in the vicinity of their clutch to signal to other females of the same species they should clutch elsewhere.” It may be helpful to note that the word epideictic, having to do with display or show (from the Greek ‘deixis’), has a different but related meaning in rhetoric, the human art of persuasion by means of words.

### D. Releaser Pheromones

Releaser pheromones are pheromones that cause an alteration in the behavior of the recipient. For example, some organisms use powerful attractant molecules to attract mates from a distance of two miles or more. In general, this type of pheromone elicits a rapid response, but is quickly degraded. In contrast, a primer pheromone has a slower onset and a longer duration. For example, rabbit (mothers) release mammary pheromones that trigger immediate nursing behavior by their babies.

### E. Signal Pheromones

Signal pheromones cause short-term changes, such as the neurotransmitter release that activates a response. For instance, GnRH molecule functions as a neurotransmitter in rats to elicit lordosis behavior.

### F. Primer Pheromones

Primer pheromones trigger a change of developmental events (in which they differ from all the other pheromones, which trigger a change in behavior).

### G. Territorial Pheromones

Laid down in the environment, territorial pheromones mark the boundaries and identity of an organism's territory. In cats and dogs, these hormones are present in the urine, which they deposit on landmarks serving to mark the perimeter of the claimed territory. In social seabirds, the preen gland is used to mark nests, nuptial gifts, and territory boundaries with behavior formerly described as ‘displacement activity’.

### H. Trail Pheromones

Social insects commonly use trail pheromones. For example, ants mark their paths with pheromones consisting of volatile hydrocarbons. Certain ants lay down an initial trail of pheromones as they return to the nest with food. This trail attracts other ants and serves as a guide. As long as the food source remains available, visiting ants will continuously renew the pheromone trail. The pheromone requires continuous renewal because it evaporates quickly. When the food supply begins to dwindle, the trail-making ceases. Pharaoh ants (Monomorium pharaonis) mark trails that no longer lead to food with a repellent pheromone, which causes avoidance behavior in ants. Repellent trail markers may help ants to undertake more efficient collective exploration. The army ant Eciton burchellii provides an example of using pheromones to mark and maintain foraging paths. When species of wasps such as Polybia sericea found new nests, they use pheromones to lead the rest of the colony to the new nesting site. Gregarious caterpillars, such as the forest tent caterpillar, lay down pheromone trails that are used to achieve group movement.

### I. Sex Pheromones

Sex pheromones are pheromones released by an organism to attract an individual of the opposite sex, encourage them to mate with them, or perform some other function closely related with sexual reproduction. Sex pheromones specifically focus on indicating females for breeding, attracting the opposite sex, and conveying information on species, age, sex and genotype. Non-volatile pheromones, or cuticular contact pheromones, are more closely related to social insects as they are usually detected by direct contact with chemoreceptors on the antennae or feet of insects. Male animals may also emit pheromones that convey information about their species and genotype. Many well-studied insect species, such as the ant Leptothorax acervorum, the moths Helicoverpa zea and Agrotis ipsilon, the bee Xylocopa sonorina and the butterfly Edith's checkerspot release sex pheromones to attract a mate, and some lepidopterans (moths and butterflies) can detect a potential mate from as far away as 10 km (6.2 mi).[20] [21] Some insects, such as ghost moths, use pheromones during lek mating.[22] Traps containing pheromones are used by farmers to detect and monitor insect populations in orchards. In addition, Colias eurytheme butterflies release pheromones, an olfactory cue important for mate selection.

Pheromones are also utilized by bee and wasp species. Some pheromones can be used to suppress the sexual behavior of other individuals allowing for a reproductive monopoly—the wasp R. marginata uses this.[25] With regard to the Bombus hyperboreus species, males, otherwise known as drones, patrol circuits of scent marks (pheromones) to find queens.[26] In particular, pheromones for the Bombus hyperboreus, include octadecenol, 2,3-dihydro-6-transfarnesol, citronellol, and geranylcitronellol.

### J. Other Attractants

Other attractants include, without limitation, nasonov pheromones (worker bees), royal pheromones (bees), necromones, given off by a deceased and decomposing organism, including oleic and linoleic acids, and 2-phenoxy ethanol, a termite trailing pheromone mimic.

In some aspects, the chemical attractant is ergosterol, 2-phenoxy ethanol, or combinations thereof.

### (e) Other Components

Other compositions that may be used in compositions of the instant disclosure include diluents, preservatives, chelating agents, and antimicrobial agents, among others. These ingredients are described in greater detail below.

### A. Diluent

Non-limiting examples of diluents (also referred to as “fillers” or “thinners”) include carbohydrates, inorganic compounds, and biocompatible polymers, such as polyvinylpirrolydone (PVP). Other non-limiting examples of diluents include dibasic calcium sulfate, tribasic calcium sulfate, starch, calcium carbonate, magnesium carbonate, microcrystalline cellulose, dibasic calcium phosphate, tribasic calcium phosphate, magnesium carbonate, magnesium oxide, calcium silicate, talc, modified starches, saccharides such as sucrose, dextrose, lactose, microcrystalline cellulose, fructose, xylitol, and sorbitol, polyhydric alcohols; starches; pre-manufactured direct compression diluents; and mixtures of any of the foregoing.

### B. Preservatives

Non-limiting examples of preservatives include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

### C. Chelating Agents

A chelating agent may be included as an excipient to immobilize oxidative groups, including but not limited to metal ions, in order to inhibit the oxidative degradation of the morphinan by these oxidative groups. Non-limiting examples of chelating agents include lysine, methionine, glycine, gluconate, polysaccharides, glutamate, aspartate, and disodium ethylenediaminetetraacetate (Na2EDTA).

### D. Antimicrobial Agents

An antimicrobial agent may be included as an excipient to minimize the degradation of the compound according to this disclosure by microbial agents, including but not limited to bacteria and fungi. Non-limiting examples of antimicrobials include parabens, chlorobutanol, phenol, calcium propionate, sodium nitrate, sodium nitrite, Na2EDTA, and sulfites including but not limited to sulfur dioxide, sodium bisulfite, and potassium hydrogen sulfite.

### E. Coloring Agents

Coloring agents can be included in the composition. Suitable color additives include, but are not limited to, food, drug and cosmetic colors (FD&C), drug and cosmetic colors (D&C), external drug and cosmetic colors (Ext. D&C), or fluorescent dyes.

### (f) Electrostatically Charged Compositions

In some aspects, the compositions exhibit an electrostatic charge on application to firmly adhere the composition to the external cuticle of a pest. The polarity of the charge can and will vary depending on the target pest, or the target environment of the pest. For instance, the cuticle of termites is negatively charged, and a positively charged composition on application is attracted to the negatively charged insect cuticle moieties, allowing adherence of the composition to the insect cuticle for efficient translocation by animal behavior into colonial groups, thereby facilitating increased control. The composition can be positively charged. Alternatively, the composition is negatively charged. In some aspects, the compositions exhibit an electrostatic charge on application to firmly adhere the composition to the environment surrounding the pest, where the composition is applied.

The composition is electrostatically charged on application. In some aspects, the composition is electrostatically charged before application. Alternatively, the composition is electrostatically charged during application using a device capable of electrostatically charging the composition during application. For instance, the device can be operable to deliver the composition via pressurized air columns. Delivery via pressurized air columns allows for particle surfaces to build static electricity. A non-limiting example of a device capable of electrostatically charging a composition of the instant disclosure is as described in U.S. patent application Ser. No. 16/880,749.

In some aspects, the pesticidal powder composition comprises fipronil at a concentration ranging from about 0.1% to about 1% w/w of from about 0.3% to about 0.7% w/w; precipitated calcium carbonate at a concentration ranging from about 0.1% to about 10% w/w or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is electrostatically charged on application. In one alternative of the aspects, the corn grit is 100 mesh or less.

In other aspects, the pesticidal powder composition comprises novaluron at a concentration ranging from about 0.05% to about 1% w/w, from about 0.1% to about 1.5% w/w, or from about 0.15% to about 0.25% w/w; precipitated calcium carbonate at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is electrostatically charged on application. In one alternative of the aspects, the corn grit is 100 mesh or less.

In yet other aspects, the pesticidal powder composition comprises indoxacarb at a concentration ranging from about 0.1% to about 5% w/w, from about 0.5% to about 1.5% w/w, or from about 0.7% to about 1% w/w; novaluron at a concentration ranging from about 0.05% to about 1% w/w, from about 0.1% to about 1.5% w/w, or from about 0.15% to about 0.25% w/w; pyriproxyfen at a concentration ranging from about 0.05% to about 1% w/w, from about 0.1% to about 1.5% w/w, or from about 0.15% to about 0.25% w/w; fumed silica at a concentration ranging from about 0.1% to about 10% w/w, from about 0.5% to about 8% w/w, or from about 0.8% to about 1.2% w/w; and brewer's yeast at a concentration ranging from about 95% to about 99.9% w/w. The composition is electrostatically charged on application. The composition can further comprise about 3% to about 7% w/w attapulgite.

In additional aspects, the pesticidal powder composition comprises indoxacarb at a concentration ranging from about 0.1% to about 5% w/w, from about 0.5% to about 1.5% w/w, or from about 0.7% to about 1% w/w; fumed silica at a concentration ranging from about 0.1% to about 10% w/w of from about 0.5% to about 8% w/w, or from about 0.8% to about 1.2% w/w; and brewer's yeast at a concentration ranging from about 95% to about 99.9% w/w. The composition is electrostatically charged on application. The composition can further comprise about 3% to about 7% w/w attapulgite.

In some aspects, the pesticidal powder composition comprises chlorfenapyr at a concentration ranging from about 0.001% to about 1% w/w, from about 0.01% to about 0.1% w/w, or from about 0.03% to about 0.07% w/w; confectioner's sugar at a concentration ranging from about 10% to about 80% w/w, from about 20% to about 70% w/w, from about 30% to about 60% w/w, or from about 40% to about 55% w/w; fumed silica at a concentration ranging from about 0.1% to about 10% w/w, from about 0.5% to about 8% w/w, or from about 0.8% to about 1.2% w/w; and powdered kidney at a concentration ranging from about 10% to about 80% w/w, from about 20% to about 70% w/w, from about 30% to about 60% w/w, or from about 40% to about 55% w/w. The composition is electrostatically charged on application. The composition can further comprise about 3% to about 7% w/w attapulgite.

In other aspects, the pesticidal powder composition comprises indoxacarb at a concentration ranging from about 0.01% to about 0.5% w/w, from about 0.05% to about 0.1% w/w, or from about 0.06% to about 0.9% w/w; confectioner's sugar at a concentration ranging from about 10% to about 80% w/w, from about 20% to about 70% w/w, from about 30% to about 60% w/w, or from about 40% to about 55% w/w; fumed silica at a concentration ranging from about 0.1% to about 10% w/w, from about 0.5% to about 8% w/w, or from about 0.8% to about 1.2% w/w; and powdered kidney at a concentration ranging from about 10% to about 80% w/w, from about 20% to about 70% w/w, from about 30% to about 60% w/w, or from about 40% to about 55% w/w. The composition is electrostatically charged on application. The composition can further comprise about 3% to about 7% w/w attapulgite.

In additional aspects, the pesticidal powder composition comprises indoxacarb at a concentration ranging from about 0.01% to about 0.5% w/w, from about 0.05% to about 0.1% w/w, or from about 0.06% to about 0.9% w/w; novaluron at a concentration ranging from about 0.005% to about 0.1% w/w, from about 0.01% to about 0.15% w/w, or from about 0.015% to about 0.025% w/w; pyriproxyfen at a concentration ranging from about 0.005% to about 0.1% w/w, from about 0.01% to about 0.15% w/w, or from about 0.015% to about 0.025% w/w; fumed silica at a concentration ranging from about 0.1% to about 10% w/w of from about 0.5% to about 8% w/w, or from about 0.8% to about 1.2% w/w; whey protein isolates at a concentration ranging from about 10% to about 80% w/w, from about 20% to about 70% w/w, from about 30% to about 60% w/w, or from about 40% to about 55% w/w; confectioner's sugar at a concentration ranging from about 10% to about 80% w/w, from about 20% to about 70% w/w, from about 30% to about 60% w/w, or from about 40% to about 55% w/w; and brewer's yeast at a concentration ranging from about 5% to about 30% w/w, from about 10% to about 20% w/w, or from about 13% to about 17% w/w. The composition is electrostatically charged on application. The composition can further comprise about 3% to about 7% w/w attapulgite.

### (g) Non-Consumable Compositions

In some aspects, the composition is a non-consumable pesticidal powder composition for control of social insects. In this aspect, the composition is attractive for translocation by the social insects into nesting, tunneling, and/or gathering structures of the social insects. In some aspects, the social insects are termites, and the composition is attractive to the termites to translocate in to the tunneling structures of the colony.

In some aspects, the composition is a non-consumable pesticidal powder composition for control of social insects comprising fipronil at a concentration ranging from about 0.1% to about 1% w/w, from about 0.3% to about 0.7% w/w; precipitated calcium carbonate at a concentration ranging from about 0.1% to about 10% or from about 0.8% to about 1.2%; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. In one alternative of the aspects, the corn grit is 100 mesh or less.

In other aspects, the composition is a non-consumable pesticidal powder composition for control of social insects comprising novaluron at a concentration ranging from about 0.05% to about 1% w/w, from about 0.1% to about 1.5% w/w, or from about 0.15% to about 0.25% w/w; precipitated calcium carbonate at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. In one alternative of the aspects, the corn grit is 100 mesh or less.

In additional aspects, the composition is a non-consumable pesticidal powder composition for control of social insects comprising fipronil at a concentration ranging from about 0.01% to about 1% w/w, from about 0.05% to about 0.5% w/w, or from about 0.08% to about 1.2% w/w; imidacloprid at a concentration ranging from about 0.001% to about 10% w/w, from about 0.1% to about 1% w/w, or from about 0.3% to about 0.7% w/w; powdered cellulose at a concentration ranging from about 0.001% to about 10% w/w, from about 0.1% to about 1% w/w, or from about 0.3% to about 0.7% w/w; precipitated calcium carbonate at a concentration ranging from about 0.1% to about 10%, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and attapulgite at a concentration ranging from about 95% to about 99.9% w/w. The composition is attractive for translocation by the social insects into nesting, tunneling, and/or gathering structures of the social insects. In one alternative of the aspects, the attapulgite is 100 mesh or less.

In yet other aspects, the composition is a non-consumable pesticidal powder composition for control of social insects comprising chlorfenapyr at a concentration ranging from about 0.01% to about 10% w/w, from about 0.1% to about 1% w/w, or from about 0.4% to about 0.8% w/w; tricalcium phosphate powder at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is attractive for translocation by the social insects into nesting, tunneling, and/or gathering structures of the social insects. In one alternative of the aspects, the corn grit is 100 mesh or less.

In some aspects, the composition is a non-consumable pesticidal powder composition for control of social insects comprising indoxacarb at a concentration ranging from about 0.1% to about 5% w/w, from about 0.5% to about 1.5% w/w, or from about 0.7% to about 1% w/w; novaluron at a concentration ranging from about 0.05% to about 1% w/w, from about 0.1% to about 1.5% w/w, or from about 0.15% to about 0.25% w/w; pyriproxyfen at a concentration ranging from about 0.05% to about 1% w/w, from about 0.1% to about 1.5% w/w, or from about 0.15% to about 0.25% w/w; ergosterol at a concentration ranging from about 0.01% to about 1% w/w, from about 0.05% to about 0.75% w/w, or from about 0.08% to about 0.12% w/w; stearic acid at a concentration ranging from about 0.2% to about 20% w/w, from about 1% to about 15% w/w, or from about 1.5% to about 2.5% w/w; bentonite at a concentration ranging from about 0.2% to about 20% w/w, from about 1% to about 15% w/w, or from about 1.5% to about 2.5% w/w; powdered chitin at a concentration ranging from about 1% to about 40% w/w, from about 5% to about 20% w/w, or from about 8% to about 12% w/w; and powdered kaolin at a concentration ranging from about 10% to about 95% w/w, from about 50% to about 90% w/w, or from about 75% to about 90% w/w. The composition is attractive for translocation by the social insects into nesting, tunneling, and/or gathering structures of the social insects. In some aspects, the bentonite is 200 mesh or finer bentonite. In some aspects, the powdered chitin is 100 mesh or finer chitin. In some aspects, the powdered kaolin is 100 mesh or finer kaolin.

### (h) Non-Consumable Electrostatically Charged Compositions

In some aspects, the composition is electrostatically charged on application and is a non-consumable composition attractive for translocation by the social insects into nesting, tunneling, and/or gathering structures of the social insects.

In some aspects, the electrostatically charged non-consumable composition comprises fipronil at a concentration ranging from about 0.1% to about 1% w/w or from about 0.3% to about 0.7% w/w; precipitated calcium carbonate at a concentration ranging from about 0.1% to about 10% w/w or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. The composition is electrostatically charged on application, and attractive for translocation by the social insects into nesting, tunneling, and/or gathering structures of the social insects. In one alternative of the aspects, the corn grit is 100 mesh or less.

In other aspects, the electrostatically charged non-consumable composition comprises novaluron at a concentration ranging from about 0.05% to about 1% w/w, from about 0.1% to about 1.5% w/w, or from about 0.15% to about 0.25% w/w; precipitated calcium carbonate at a concentration ranging from about 0.1% to about 10% w/w, from about 0.5% to about 8% w/w, or from about 0.8% to about 1.2% w/w; 2-phenoxy ethanol at a concentration ranging from about 0.01% to about 1% w/w, from about 0.05% to about 0.75% w/w, or from about 0.08% to about 0.12% w/w; and corn grit at a concentration ranging from about 95% to about 99.9% w/w. In one alternative of the aspects, the corn grit is 100 mesh or less.

### (i) Additional Aspects

One aspect of the present disclosure encompasses a composition comprising one or more pesticidal ingredient, one or more anticaking agent, and one or more attractant. The attractant can be brewer's yeast, dried distiller's grain, powdered kidney, whey protein, confectioner's sugar, or any combination thereof. Further, the anticaking agent can be precipitated calcium carbonate, stearic acid, tricalcium phosphate, silica, or any combination thereof. In some aspects, the anticaking agent can be fumed silica, precipitated silica, hydrophobic silica, or any combination thereof. In some aspects, the composition are about 125 μm or less in size. In some aspects, the moisture content of the composition ranges from about 2% to about 5% w/w.

The composition can be electrostatically charged. In some aspects, the composition is electrostatically charged during application using a device operable to electrostatically charge the composition during application.

The pest can be a roach. When the pest is a roach, the composition can be electrostatically charged using a device operable to electrostatically charge the composition during application.

In some aspects, the composition is non-consumable. When the composition is non-consumable none of the ingredients of the composition are consumable.

Another aspect of the instant disclosure encompasses a non-consumable pesticidal powder composition comprising one or more pesticidal ingredient, one or more anticaking agent, one or more environmentally mimicking agent, and optionally one or more non-food attractant. In some aspects, none of the ingredients of the composition are consumable. The particles of the composition can be about 125 μm or less in size. The composition can comprise a moisture content ranging from about 0.2% to about 5% w/w.

The anticaking agent can be precipitated calcium carbonate, stearic acid, tricalcium phosphate, silica, or any combination thereof. In some aspects, the anticaking agent is precipitated calcium carbonate. Further, the environmentally mimicking agent can be attapulgite, bentonite, powdered chitin, powdered kaolin, silica, or any combination thereof.

In some aspects, the pest is a termite. When the pest is a termite, the composition can be electrostatically charged using a device operable to electrostatically charge the composition during application, and the device can be operable for precise application into nesting, tunneling, and/or gathering structures of termites.

Yet another aspect of the instant disclosure encompasses a pesticidal powder composition for controlling a target pest comprising fipronil at a concentration ranging from about 0.3% to about 0.7% w/w, precipitated calcium carbonate at a concentration ranging from about 0.8% to about 1.2% w/w, 2-phenoxy ethanol at a concentration ranging from about 0.08% to about 0.12% w/w, and corn grit at a concentration ranging from about 95% to about 99.9% w/w. The composition can be electrostatically charged, and the corn grit can be 100 mesh or less.

An additional aspect of the instant disclosure encompasses a pesticidal powder composition for controlling a target pest comprising novaluron at a concentration ranging from about 0.15% to about 0.25% w/w, precipitated calcium carbonate at a concentration ranging from about 0.8% to about 1.2% w/w, 2-phenoxy ethanol at a concentration ranging from about 0.08% to about 0.12% w/w and corn grit at a concentration ranging from about 95% to about 99.9% w/w. The composition can be electrostatically charged, and the corn grit can be 100 mesh or less.

One aspect of the instant disclosure encompasses a pesticidal powder composition for controlling a target pest. The composition comprises indoxacarb at a concentration ranging from about 0.7% to about 1% w/w, novaluron at a concentration ranging from about 0.15% to about 0.25% w/w, pyriproxyfen at a concentration ranging from about 0.15% to about 0.25% w/w, silica at a concentration ranging from about 0.8% to about 1.2% w/w, and brewer's yeast at a concentration ranging from about 95% to about 99.9% w/w. The composition can be electrostatically charged on application. In some aspects, the silica is fumed silica, precipitated silica, hydrophobic silica, or any combination thereof. In one aspect, the silica is fumed silica.

An additional aspect of the instant disclosure encompasses a pesticidal powder composition for controlling a target pest, the composition comprising indoxacarb at a concentration ranging from about 0.5% to about 0.7% w/w, silica at a concentration ranging from about 0.8% to about 1.2% w/w, and brewer's yeast at a concentration ranging from about 95% to about 99.9% w/w. The composition can be electrostatically charged on application. In some aspects, the silica is fumed silica, precipitated silica, hydrophobic silica, or any combination thereof. In one aspect, the silica is fumed silica.

Another aspect of the instant disclosure encompasses a pesticidal powder composition for controlling a target pest, the composition comprising indoxacarb at a concentration ranging from about 0.5% to about 0.7% w/w, silica at a concentration ranging from about 0.8% to about 1.2% w/w, and distiller's dried grain at a concentration ranging from about 95% to about 99.9% w/w. The composition can be electrostatically charged on application. In some aspects, the silica is fumed silica, precipitated silica, hydrophobic silica, or any combination thereof. In one aspect, the silica is fumed silica. In some aspects, the distiller's dried grain is corn distiller's dried grain with solubles.

Yet another aspect of the instant disclosure encompasses a pesticidal powder composition for controlling a target pest. The composition comprises indoxacarb at a concentration ranging from about 0.5% to about 0.7% w/w; fumed silica at a concentration ranging from about 0.8% to about 1.2% w/w; and distiller's dried grain at a concentration ranging from about 95% to about 99.9% w/w. The composition can be electrostatically charged.

One aspect of the instant disclosure encompasses a pesticidal powder composition for controlling a target pest. The composition comprises chlorfenapyr at a concentration ranging from about 0.03% to about 0.07% w/w; confectioner's sugar at a concentration ranging from about 40% to about 55% w/w; silica at a concentration ranging from about 0.8% to about 1.2% w/w; and powdered kidney at a concentration ranging from about 40% to about 55% w/w. The composition can be electrostatically charged on application. In some aspects, the silica is fumed silica, precipitated silica, hydrophobic silica, or any combination thereof. In one aspect, the silica is fumed silica.

An additional aspect of the instant disclosure encompasses a pesticidal powder composition for controlling a target pest, the composition comprising indoxacarb at a concentration ranging from about 0.06% to about 0.9% w/w; confectioner's sugar at a concentration ranging from about 40% to about 55% w/w; silica at a concentration ranging from about 0.8% to about 1.2% w/w; and powdered kidney at a concentration ranging from about 40% to about 55% w/w. The composition can be electrostatically charged on application. In some aspects, the silica is fumed silica, precipitated silica, hydrophobic silica, or any combination thereof. In one aspect, the silica is fumed silica.

Yet another aspect of the instant disclosure encompasses a pesticidal powder composition for controlling a target pest. The composition comprises indoxacarb at a concentration ranging from about 0.06% to about 0.9% w/w; novaluron at a concentration ranging from about 0.01% 5 to about 0.025% w/w; pyriproxyfen at a concentration ranging from about 0.015% to about 0.025% w/w; silica at a concentration ranging from about 0.8% to about 1.2% w/w; whey protein isolates at a concentration ranging from about 40% to about 55% w/w; confectioner's sugar at a concentration ranging from about 40% to about 55% w/w; and brewer's yeast at a concentration ranging from about 13% to about 17% w/w. The composition can be electrostatically charged on application. In some aspects, the silica is fumed silica, precipitated silica, hydrophobic silica, or any combination thereof. In one aspect, the silica is fumed silica.

One aspect of the instant disclosure encompasses a non-consumable pesticidal powder composition. The composition comprises fipronil at a concentration ranging from about 0.3% to about 0.7% w/w; precipitated calcium carbonate at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w. The corn grit can be 100 mesh or less.

An additional aspect of the instant disclosure encompasses a non-consumable pesticidal powder composition, the composition comprising novaluron at a concentration ranging from about 0.15% to about 0.25% w/w; precipitated calcium carbonate at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w. The corn grit can be 100 mesh or less.

Another aspect of the instant disclosure encompasses a non-consumable pesticidal powder composition, the composition comprising fipronil at a concentration ranging from about 0.08% to about 1.2% w/w; imidacloprid at a concentration ranging from about 0.3% to about 0.7% w/w; powdered cellulose at a concentration ranging from about 0.3% to about 0.7% w/w; precipitated calcium carbonate at a concentration ranging from about 0.8% to about 1.2% w/w; 2-phenoxy ethanol at a concentration ranging from about 0.08% to about 0.12% w/w; and attapulgite at a concentration ranging from about 95% to about 99.9% w/w. The attapulgite can be 100 mesh or less.

An additional aspect of the instant disclosure encompasses a non-consumable pesticidal powder composition. The composition comprises chlorfenapyr at a concentration ranging from about 0.4% to about 0.8% w/w; tricalcium phosphate powder at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w. The corn grit can be 100 mesh or less.

Yet another aspect of the instant disclosure encompasses a non-consumable pesticidal powder composition, the composition comprising indoxacarb at a concentration ranging from about 0.7% to about 1% w/w; novaluron at a concentration ranging from about 0.15% to about 0.25% w/w; pyriproxyfen at a concentration ranging from about 0.15% to about 0.25% w/w; ergosterol at a concentration ranging from about 0.08% to about 0.12% w/w; stearic acid at a concentration ranging from about 1.5% to about 2.5% w/w; bentonite at a concentration ranging from about 1.5% to about 2.5% w/w; powdered chitin at a concentration ranging from about 8% to about 12% w/w; and powdered kaolin at a concentration ranging from about 75% to about 90% w/w. The bentonite, the powdered chitin, and the powdered kaolin can be 100 mesh or less.

Another aspect of the instant disclosure encompasses a n electrostatically charged non-consumable composition. The composition comprises novaluron at a concentration ranging from about 0.15% to about 0.25% w/w; precipitated calcium carbonate at a concentration ranging from about 0.8% to about 1.2% w/w; 2-phenoxy ethanol at a concentration ranging from about 0.08% to about 0.12% w/w; and corn grit at a concentration ranging from about 95% to about 99.9% w/w; wherein the composition is electrostatically charged on application. The corn grit can be 100 mesh or less.

An additional aspect of the instant disclosure encompasses an electrostatically charged non-consumable composition, the composition comprising indoxacarb at a concentration ranging from about 0.7% to about 1% w/w; novaluron at a concentration ranging from about 0.15% to about 0.25% w/w; pyriproxyfen at a concentration ranging from about 0.15% to about 0.25% w/w; fumed silica at a concentration ranging from about 0.8% to about 1.2% w/w; and brewer's yeast at a concentration ranging from about 95% to about 99.9% w/w.

### II. Methods

Another aspect of the present disclosure encompasses a method of controlling a pest. The method comprises applying to a site where control is sought a pesticidally effective amount of a dry flowable pesticidal powder composition. The powder compositions can be as described in Section I above.

The composition can be applied by manually sprinkling the composition at the site. Alternatively, the composition can be applied using a powder spray unit. In some aspects, the powder spray unit can be as described in Section I(f) above.

In some aspects the method comprises using a powder delivery device operable to electrostatically charge a powder composition during delivery to apply a pesticidal composition to a site where control is sought. In an aspect, the pesticidal powder composition comprises: indoxacarb at a concentration ranging from about 0.5% to about 0.7% w/w; silica at a concentration ranging from about 0.8% to about 1.2% w/w; and brewer's yeast or distiller's dried grain at a concentration ranging from about 95% to about 99.9% w/w. In some aspects, the powder spray unit is a device described in U.S. patent application Ser. No. 16/880,749.

Non-limiting examples of pest species include insects such as termites, carpenter ants, fire ants and roaches, mosquitoes, ticks, fleas, flies, chiggers, lice, mites, and roaches. Other pests include arachnid and crustacean species many of which are vectors of human disease-causing agents.

### DEFINITIONS

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above-described cells and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Electrostatically Charging a Flowable Powder Composition Using a PDS Device

A test was used to determine if a charge was developed on particles of a composition during application using a PDS device. In short, a powder composition comprising 0.5% fipronil, 1% precipitated calcium carbonate, 0.1% 2-phenoxy ethanol, and 98.4% corn grit 100 mesh or finer was applied to a negatively charged vertical surface using the Precision Delivery Device (PDS device) from Control Solutions Inc. described in U.S. application Ser. No. 16/880,749. The ability of the composition to attach to the surface was evaluated.

Based on this study it was demonstrated that voltage is added to the powder during the application procedure. Charge increased as more composition was applied. Peak voltages were reached within 30 seconds of continuous application.

### Example 2. Efficacy of a Powder Composition at Controlling Termites

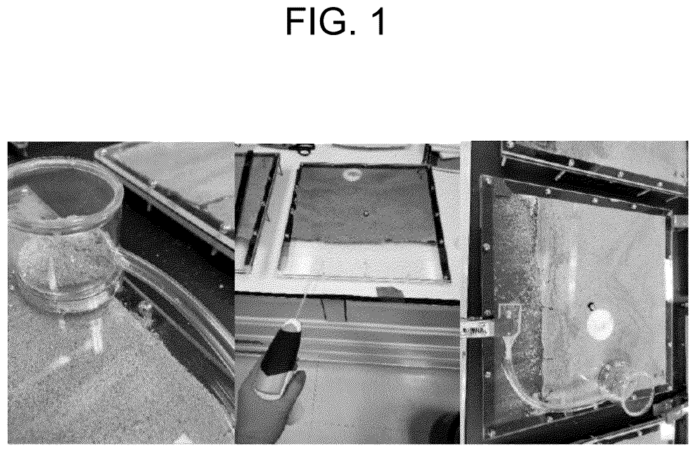

A test was used to determine the efficacy of the composition of Example 1 against subterranean termites in a modified void treatment. Thin plate arenas were constructed (FIG. 1) with moist sand, a food source, and a void space at the top of the arena. The void space was treated with approximately 0.1 g of the composition using a PDS device.

Termites (Reticulitermes flavipes; 200 workers, 3 soldiers) were introduced via the out world (FIG. 1, panel 1; plastic cylinder connected to the arena with Tygon tubing) into the void space and were forced to pass through the treated zone to reach food/moist sand. Total tunneling distance (Table 1) and mortality (Table 2) were measured daily after 24 h.

TABLE 1
Tunneling distance

| Hour | Treatment | Mean |
|---|---|---|
| 24 | Control | 19.57^{b} |
| 48 | Control | 46.29^{a} |
| 24 | Powder composition | 2.86^{c} |
| 48 | Powder composition | 2.86^{c} |

Corresponding superscript letters are statistically similar.

TABLE 2
Mortality.

| Hour | Treatment | Mean | Mean |
|---|---|---|---|
| 24 | Control | 0.86^{a} | 0.43% |
| 48 | Control | 0.86^{a} | 0.00% |
| 24 | Powder composition | 197.86^{b} | 98.93% |
| 48 | Powder composition | 200^{b} | 100% |

Corresponding superscript letters are statistically similar.

The powder composition killed >90% of the termites introduced to the arenas after 25 hours, and 100% of the termites after 48 hours. Further, the tunneling distance greatly reduced in the treated arenas.

### Example 3. Efficacy of Powder Compositions Against Cockroaches

The objective of this study was to evaluate the efficacy of two dry flowable cockroach baits compared with an industry standard (Avert) against pyrethroid resistant German cockroaches under laboratory conditions using a “Forced Exposure Test” experimental design.

In vitro bioassay systems are very efficient in the evaluation of the intrinsic activity of insecticide formulations against target pest species. The ability to evaluate pest arthropods against candidate formulations under controlled laboratory conditions is critical in determining the efficacy of a product to support its registration, expand label claims or provide additional technical information. These evaluations were designed to determine the efficacy of the two (2) dry flowable cockroach bait formulations compared with an industry standard (Avert Dry Flowable) and untreated controls against a recently field collected pyrethroid resistant strain of German cockroaches evaluated in laboratory test arenas.

Test substances used in the study include 101-077 Indoxacarb Dust Bait with Solulac A101, 0.6000% S-Indoxacarb; 101-079 Indoxacarb Cockroach Dust Bait, 0.6000% S-Indoxacarb; and Avert DF (BASF 67019408 NVA2014-05-413-0357)—Abamectin B1 0.050%, Related Compounds 0.0004%, EPA Reg. No. 499-294, Lot 203801926 15 062. The test insects are German Cockroaches, Blattella germanica—mixed sex (“Paradise” field strain, pyrethroid resistant, P¹ generation) obtained from Sierra Research Laboratories, Modesto, CA.

The test substances were stored in their original sealed containers in the SRL Chemical Storage Area under ambient temperature (° F.), relative humidity (% RH), and light conditions. Laboratory chemical storage area environmental monitoring was conducted and recorded with SRL temperature and humidity recording devices (min/max) and the data are included in the Appendices.

### Treatments:

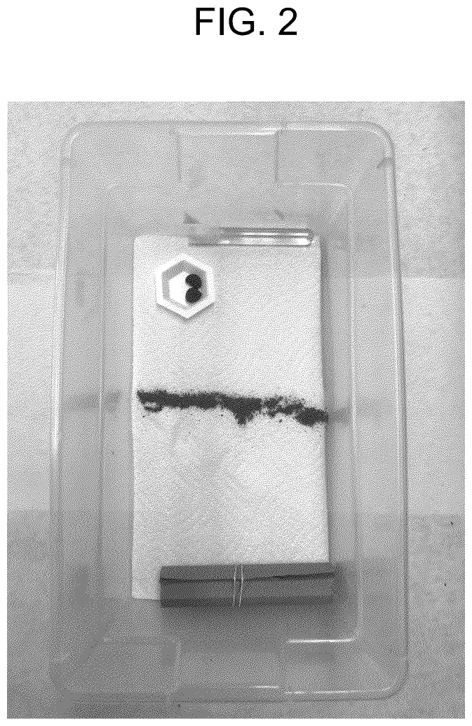

Approximately 25-medium to large nymphs, 10 non-gravid females and 10 male German cockroaches were anesthetized with CO2 then placed into each test arena. The arena was 163/4″ L×117/8″ W×7″ H (42.5 cm×30.2 cm×17.8 cm), 16 Qt. (15 L) Sterlite® clear plastic box. Each arena contained rolled corrugated cardboard for harborage, a water tube (test tube with cotton ball) and small plastic weigh boat with cockroach diet (dry puppy chow). The harborage was on one side of the chamber and the food and water on the other side. A mineral oil/petroleum jelly mixture was applied to the sides to prevent escape (FIG. 2). The cockroaches were acclimated to the arenas for three (3) days and food was withheld 24 hours prior to bait placement.

Approximately 0.5 grams of bait was placed directly on the bottom of the container in a line completely bisecting the container to force the cockroaches to cross the treatment to obtain food and water. All containers were labeled with SRL project I.D. #, treatment, arthropod species, replicate number and date.

### Efficacy Assessments:

Each replicate was observed for the number of German cockroaches alive, affected, moribund, and dead (mortality) at 1, 3, 7, 10 and 14 post treatment. Each sex or life stage was recorded separately for each of the efficacy categories. Dead cockroaches were removed from the test arenas at each evaluation time.

### Efficacy Determinations:

Comparisons of means were evaluated on pooled data from each treatment group. Data were collected for each replicate and each life stage but pooled to determine a mean percent effect for that treatment group. The average percent control was determined and corrected if the control mortality exceeded 10% using Schneider-Orelli's (1941) formula:

$$Corrected Mortality = \frac{Mortality \% in treated group - Mortality \% in control group}{100 - Mortality \% in control group} \times 100$$

### RESULTS & DISCUSSION

The percent affected and moribund cockroaches on Test Day 1 was between 13.5 and 27.3 for the 101-079 and 101-077 indoxacarb dust baits, respectively (Table 3). Mortality was not observed in any of the treated groups until Test Day 3 (Table 4), indicating a delayed toxic effect of the bait, but not necessarily lethal until at least a day after consumption/exposure. Both experimental baits performed similarly to each other from Test Day 7 through Test Day 14, with mortality reaching greater than 97.0% by Day 10, and greater than 98.3% by Day 14. Indoxacarb Dust Bait 101-077 slightly outperformed 101-079 at all data points (Tables 3 & 4). Avert DF outperformed both experimental baits at each data point, however, there was no significant difference in any of the baits past the Day 10 data point.

Due to higher than expected mortality in the untreated control group, the data were corrected using the Schneider-Orelli's (1941) formula on Test Days 7, 10, and 14.

TABLE 3
Corrected (Schneider-Orelli) percent affected + moribund + cumulative
mortality for all life stages of German cockroaches, Blattella germanica,
at 1, 3, 7, 10 and 14 days post treatment for three (3) dry flowable
cockroach baits compared to untreated controls (n = 5).

| | Avg. % Affected + Moribund + | | | | |
|---|---|---|---|---|---|
| | Cumulative Mortality | | | | |
| Treatment | Day 1 | Day 3 | Day 7 | Day 10 | Day 14 |
| 101-077 Indoxacarb Dust Bait | 27.3 | 76.6 | 82.8 | 99.8 | 99.2 |
| 101-079 Indoxacarb Dust Bait | 13.5 | 47.1 | 78.7 | 97.6 | 98.3 |
| Avert DF | 30.0 | 89.2 | 97.3 | 98.9 | 100 |
| UTC | 6.7 | 9.0 | 11.9 | 15.2 | 22.4 |

TABLE 4
Cumulative corrected (Schneider-Orelli) percent mortality only for all
life stages of German cockroaches, Blattella germanica, at 1, 3, 7, 10
and 14 days post treatment for three (3) dry flowable cockroach baits
compared to untreated controls (n = 5).

| | Avg. % Cumulative Mortality | | | | |
|---|---|---|---|---|---|
| Treatment | Day 1 | Day 3 | Day 7 | Day 10 | Day 14 |
| 101-077 Indoxacarb Dust Bait | 0.6 | 48.7 | 80.8 | 98.5 | 99.2 |
| 101-079 Indoxacarb Dust Bait | 0.0 | 25.2 | 78.0 | 97.0 | 98.3 |
| Avert DF | 0.0 | 40.8 | 97.3 | 98.9 | 100 |
| UTC | 6.7 | 9.0 | 11.9 | 15.2 | 22.4 |

### CONCLUSIONS

Indoxacarb Dust Baits 101-077 and 101-079 are both efficacious (≥90% mortality) against German cockroach populations when exposed to the baits for a period of 14 days in the laboratory.

### Example 4. Efficacy of Powder Compositions Against German Cockroaches Over a Period of 1 Year

The objective of this study was to evaluate the effectiveness of 0.6% Indoxacarb baits against German cockroaches (Blattella germanica) under “choice” laboratory conditions.

| | | | EPA Reg. | | |
|---|---|---|---|---|---|
| | | | No. and/or | Lot and/or | Snell Receipt |
| # | Test Substance | Active Ingredients | Est. No. | Batch # | Code |
| 1 | Controls—Untreated | N/A | N/A | N/A | N/A |
| 2 | Indoxacarb Cockroach | 0.6% Indoxacarb | N/A | N/A | 102016-1-C-DHN |
| | Dust Bait (101-079) | | | | |
| 3 | Indoxacarb Dust Bait with | 0.6% Indoxacarb | N/A | N/A | 102016-2-C-DHN |
| | Solulac A101 (101-077) | | | | |
| 4 | Abamectin Dry Flowable | 0.05% Abamectin | N/A | ECS-37-123 | 111616-1-C-DHN |
| | Bait w/ Distillers Grain | | | | |
| | (ECS-F-645) | | | | |
| 5 | Abamectin Dry Flowable | 0.05% Abamectin | N/A | ECS-37-131 | 111616-2-C-DHN |
| | Bait (ECS-F-457) | | | | |
| 6 | Avert ® DF Dry Flowable | 0.050% Abamectin | EPA Reg. No. | N/A | 013017-1-C-SNE |
| | Cockroach Bait | B1 | 499-294 | | |

| | Test | | | |
|---|---|---|---|---|
| Trial | System | Strain | Stage/Age | Source |
| BLTTGE | German | Lab | 80% Nymphs, | Purchased/ |
| | Cockroach | | 10% Males, | Lab Reared |
| | (Blattella | | 10% Non-Gravid | |
| | germanica) | | Females | |

The number of replicates conducted per test substance and the number of test systems evaluated per replicate were as follows for each aged evaluation:

| # Reps | | # Systems |
|---|---|---|
| per Substance | # Systems per Rep | per Substance |
| 5 | 10 | 50 |

### Test Substance Preparation & Applications:

The applications were conducted using an application rate of 1.0 gram per PVC pipe. The treatments were applied so that the entire inner pipe surface was treated as evenly as possible.

All test substances were evaluated immediately after applications (0 month) and the Indoxacarb test substances were evaluated again at 12 months after aging. The treated pipes were held under ambient laboratory condition and in the dark during aging.

### Observation Methods:

The number of “Alive”, “Knockdown (KD)”, and “Dead” test systems per container were recorded prior to the addition of the test substances (Pre-trt), and then daily for up to 12 days after the bait offering.

The “Alive”, “Knockdown (KD)”, and “Dead” observations were collected by raising the test arenas and gently blowing air on the test systems to provoke movement, lightly prodding the test systems, or the test arenas were shaken/agitated to provoke test system movement.

Definitions of “Alive”, “Knockdown (KD)”, and “Dead”:
Alive—Test System exhibited normal forward motion.
Knockdown (KD)—Test System exhibited some movement but could not crawl.
Dead—Test System exhibited no movement, even when stimulated.

### DISCUSSION

The results of this study are illustrated in Table 5, which shows the mortality rates of the German cockroaches (Blattella germanica) at each observation interval during the study. In addition to the percent mortality that is shown in the table, the mortality rates that were recorded were statistically analyzed using a t-test with a probability value of p≤0.05 to evaluate if any significant differences were recorded between the control population and/or between the populations that were offered the bait formulations.

The Indoxacarb baits provided the fastest mortality of the experimental formulations during the 0-month aged evaluation. The 101-079 provided the fastest mortality rates of the two Indoxacarb baits, and Indoxacarb baits recorded ≥90% mortality within 4-days of the bait offering and they reached 100% mortality at day-5 (101-077) and day-8 (101-079). The ECS-F-645 bait formulation provided the best results of the two experimental Abamectin formulations. The ECS-F-645 bait recorded 94% mortality within 6-days of the bait offering and reached 100% mortality at day-8. In comparison, the ECS-F-457 bait formulation recorded 100% mortality at day-12. The Avert® DF bait recorded 100% mortality at day-4. Statistically, the Indoxacarb bait formulations proved comparable to each other and the Abamectin bait formulations also proved comparable to each other. Significant difference was recorded between the different actives however, with the Indoxacarb baits providing significantly better mortality than the Abamectin bait formulations.

Like the 0-month evaluation, the Indoxacarb baits provided similar mortality rates to each other and there was no significant difference in efficacy between the two baits when evaluated at 12-months after aging. The Indoxacarb baits recorded ≥90% mortality again at 4-days after the bait offering and they reached 100% mortality at day-5 (101-077) and day-6 (101-079).

### CONCLUSION

It is evident from the results of the study that both the 101-077 and 101-079 Indoxacarb bait formulations are effective against German cockroaches (Blattella germanica) for up to 12-months after applying. The results also prove that the Abamectin baits (ECS-F-645 and ECS-F-457) are effective when used as a fresh application (0-month).

German Cockroach % Mortality

| Aged | Test | Pre- | | 2 | 3 | 4 | 5 | 6 | 7 | 8 | 9 | 10 | 11 | 12 |
|---|---|---|---|---|---|---|---|---|---|---|---|---|---|---|
| Eval: | Substance: | trt | 24 hr | DAT | DAT | DAT | DAT | DAT | DAT | DAT | DAT | DAT | DAT | DAT |
| 0 | Untreated | 0% | 0% | 0% | 0% | 0% | 0% | 0% | 4% | 4% | 12% | 18% | 22% | 24% |
| Month | Indoxacarb | 0% | 52% | 70% | 82% | 90% | 94% | 96% | 98% | 100% | 100% | 100% | 100% | 100% |
| | (101-079) | | | | | | | | | | | | | |
| | Indoxacarb | 0% | 14% | 34% | 72% | 94% | 100% | 100% | 100% | 100% | 100% | 100% | 100% | 100% |
| | (101-077) | | | | | | | | | | | | | |
| | Abamectin | 0% | 0% | 5% | 17% | 47% | 82% | 94% | 98% | 100% | 100% | 100% | 100% | 100% |
| | (ECS-F-645) | | | | | | | | | | | | | |
| | Abamectin | 0% | 0% | 11% | 17% | 35% | 51% | 63% | 67% | 79% | 87% | 91% | 96% | 100% |
| | (ECS-F-457) | | | | | | | | | | | | | |
| | Avert ® DF | 0% | 14% | 66% | 96% | 100% | 100% | 100% | 100% | 100% | 100% | 100% | 100% | 100% |
| 12 | Untreated | 0% | 0% | 0% | 0% | 0% | 2% | 4% | | | | | | |
| Month | Indoxacarb | 0% | 16% | 48% | 78% | 90% | 98% | 100% | | | | | | |
| | (101-079) | | | | | | | | | | | | | |
| | Indoxacarb | 0% | 14% | 44% | 64% | 92% | 100% | 100% | | | | | | |
| | (101-077) | | | | | | | | | | | | | |

### Example 5. Efficacy of Powder Compositions Against German Cockroaches over a Period of 2 Years

The objective of this study was to evaluate the efficacy of 0.6% Indoxacarb and 0.05% Abamectin baits against German cockroaches (Blattella germanica) under “choice” laboratory conditions over a period of 2 years.

| | | | EPA Reg. | | |
|---|---|---|---|---|---|
| | | Active | No. and/or | Lot and/or | Snell Receipt |
| # | Test Substance | Ingredients | Est. No. | Batch # | Code |
| 1 | Controls-Untreated | N/A | N/A | N/A | N/A |
| 2 | Indoxacarb Cockroach | 0.6% | N/A | N/A | 102016-1-C- |
| | Dust Bait (101-079) | Indoxacarb | | | DHN |
| 3 | Indoxacarb Dust Bait | 0.6% | N/A | N/A | 102016-2-C- |
| | with Solulac A101 | Indoxacarb | | | DHN |
| | (101-077) | | | | |
| 4 | Abamectin Dry | 0.05% | N/A | ECS-37-123 | 111616-1-C- |
| | Flowable Bait w/ | Abamectin | | | DHN |
| | Distillers Grain | | | | |
| | (ECS-F-645) | | | | |
| 5 | Abamectin Dry | 0.05% | N/A | ECS-37-131 | 111616-2-C- |
| | Flowable Bait | Abamectin | | | DHN |
| | (ECS-F-457) | | | | |
| 6 | Avert ® DF Dry | 0.050% | EPA Reg. | N/A | 013017-1-C- |
| | Flowable Cockroach | Abamectin B1 | No. 499-294 | | SNE |
| | Bait | | | | |

| | Test | | | |
|---|---|---|---|---|
| Trial | System | Strain | Stage/Age | Source |
| BLTTGE | German | Lab | 80% Nymphs, | Purchased/ |
| | Cockroach | | 10% Males, | Lab Reared |
| | (Blattella | | 10% Non-Gravid | |
| | germanica) | | Females | |

### MATERIALS AND METHODS

The number of replicates conducted per test substance and the number of test systems evaluated per replicate were as follows for each aged evaluation:

| # Reps | | # Systems |
|---|---|---|
| per Substance | # Systems per Rep | per Substance |
| 5 | 10 | 50 |

### Test Substance Preparation & Applications:

The applications were conducted using an application rate of 1.0 gram per PVC pipe. The treatments were applied so that the entire inner pipe surface was treated as evenly as possible.

All test substances were evaluated immediately after applications (0 month) and the Indoxacarb test substances were evaluated again at 12 and 24 months after aging. The 0 month treated pipes were held under ambient laboratory conditions and in the dark during aging and then the same treated pipes were re-evaluated at 12 and 24 months.

### Observation Methods:

The number of “Alive”, “Knockdown (KD)”, and “Dead” test systems per container were recorded prior to the addition of the test substances (Pre-trt), and then daily for up to 12 days after the bait offering.

The “Alive”, “Knockdown (KD)”, and “Dead” observations were collected by raising the test arenas and gently blowing air on the test systems to provoke movement, lightly prodding the test systems, or the test arenas were shaken/agitated to provoke test system movement.

Definitions of “Alive”, “Knockdown (KD)”, and “Dead”:
Alive—Test System exhibited normal forward motion.
Knockdown (KD)—Test System exhibited some movement but could not crawl.
Dead—Test System exhibited no movement, even when stimulated.

### STATISTICAL ANALYSIS

Two separate analyses were performed by the Sponsor using Minitab 18 (Minitab, Inc., State College, PA). The first analyzed the initial (2017) efficacy data for the two CSI indoxacarb bait formulations, Avert DF, and two experimental abamectin bait formulations. The second analyzed the 24-month efficacy data for the two CSI indoxacarb bait formulations.

### Initial Efficacy (2017)

The number of dead German cockroaches 10 days after treatment was the dependent variable. The Kolmogorov-Smirnov test was used to test the null hypothesis that the data came from a normal distribution. The null hypothesis was rejected (p<0.01), and the counts were transformed using In(count+1) before analysis.

A one-way analysis of variance (ANOVA) with treatment as the single factor was used to test the following hypotheses:

| | |
|---|---|
| Null hypothesis: | All treatment means are equal |
| Alternative hypothesis: | Not all means are equal |
| Significance level: | α = 0.05 |

Treatment means were compared using Fisher's Least Significant Difference (LSD) test (α=0.05).

### 24-Month Efficacy (2017-2019)

Counts of dead German cockroaches from the final day after treatment (DAT) on which counts were performed at each time point (2017—10 DAT; 2018—6 DAT; 2019—7 DAT) was the dependent variable. The Kolmogorov-Smirnov test was used to test the null hypothesis that the data came from a normal distribution. The null hypothesis was rejected (p<0.01), and the counts were transformed [In(count+1)] before analysis of variance (ANOVA) was performed.

Terms used in the ANOVA were treatment (TRT), year and the interaction of treatment and year (TRT×year). The TRT×year interaction was significant (p≤0.05), so the treatment groups were compared to the control at each time point. These comparisons were performed using Fisher's LSD test (α=0.05).

### RESULTS

### Initial Efficacy (2017)

The two CSI indoxacarb baits and Avert DF killed 100% of the cockroach nymphs and adults (10 out of 10/rep) in 10 days. The two other abamectin baits (ABA DFB-DG and ABA DFB) killed 96% and 81%, respectively. There were no significant differences (p>0.05) in the mean number of dead roaches between any of the baits (Table 5). The numbers of dead cockroaches for all baits were significantly different from the control (p<0.05; Table 5).

### 24-Month Efficacy (2017-2019)

Both CSI indoxacarb bait formulations killed 100% (10 out of 10/rep) of the German cockroaches (adults and nymphs) at all three time points (2017, 2018 and 2019). There were no significant differences (p>0.05) in the numbers of dead roaches for the two baits at any time point (Table 6). The numbers of dead cockroaches for both baits at all three time points were statistically different (p<0.05) from all controls (Table 6).

### CONCLUSION

Both Control Solutions' indoxacarb bait formulations provided 100% control of German cockroach adults and nymphs 2 years after a single application.

TABLE 5
Mean number of dead German cockroaches per
replicate (n = 10/rep) 10 days after treatment. Means
followed by a different letter are significantly different (p < 0.05).

| Treatment | Mean | | |
|---|---|---|---|
| CSI Indox DB-S | 10 | a | |
| CSI Indox DB | 10 | a | |
| Avert DF | 10 | a | |
| ABA DFB-DG | 9.6 | a | |
| ABA DFB | 8.1 | a | |
| Control | 1.7 | | b |

TABLE 6
Mean number of dead German cockroaches per
replicate (n = 10/rep). Means followed by a
different letter are significantly different (p < 0.05).

| Treatment X Year | Mean | | | |
|---|---|---|---|---|
| CSI Indox DB X 2017 | 10 | a | | |
| CSI Indox DB X 2018 | 10 | a | | |
| CSI Indox DB X 2019 | 10 | a | | |
| CSI Indox DB-S X 2019 | 10 | a | | |
| CSI Indox DB-S X 2018 | 10 | a | | |
| CSI Indox DB-S X 2017 | 10 | a | | |
| Control X 2017 | 1.7 | | b | |
| Control X 2019 | 0.5 | | | c |
| Control X 2018 | 0.2 | | | c |

TABLE 7

| Aged | Test | Pre- | | 2 | 3 | 4 | 5 | 6 | 7 | 8 | 9 | 10 | 11 | 12 |
|---|---|---|---|---|---|---|---|---|---|---|---|---|---|---|
| Eval: | Substance: | trt | 24 hr | DAT | DAT | DAT | DAT | DAT | DAT | DAT | DAT | DAT | DAT | DAT |
| 0 | Controls-Untreated | 0% | 0% | 0% | 0% | 0% | 0% | 0% | 4% | 4% | 12% | 18% | 22% | 24% |
| Month | Indoxacarb (101-079) | 0% | 52% | 70% | 82% | 90% | 94% | 96% | 98% | 100% | 100% | 100% | 100% | 100% |
| | Indoxacarb (101-077) | 0% | 14% | 34% | 72% | 94% | 100% | 100% | 100% | 100% | 100% | 100% | 100% | 100% |
| | Abamectin (ECS-F-645) | 0% | 0% | 5% | 17% | 47% | 82% | 94% | 98% | 100% | 100% | 100% | 100% | 100% |
| | Abamectin (ECS-F-457) | 0% | 0% | 11% | 17% | 35% | 51% | 63% | 67% | 79% | 87% | 91% | 96% | 100% |
| | Avert ® DF | 0% | 14% | 66% | 96% | 100% | 100% | 100% | 100% | 100% | 100% | 100% | 100% | 100% |
| 12 | Controls-Untreated | 0% | 0% | 0% | 0% | 0% | 2% | 4% | | | | | | |
| Month | Indoxacarb (101-079) | 0% | 16% | 48% | 78% | 90% | 98% | 100% | | | | | | |
| | Indoxacarb (101-077) | 0% | 14% | 44% | 64% | 92% | 100% | 100% | | | | | | |
| 24 | Controls-Untreated | 0% | 0% | 0% | 0% | 0% | 0% | 2% | 6% | | | | | |
| Month | Indoxacarb (101-079) | 0% | 10% | 42% | 62% | 80% | 94% | 98% | 100% | | | | | |
| | Indoxacarb (101-077) | 0% | 6% | 50% | 80% | 96% | 100% | 100% | 100% | | | | | |

### Example 6. Efficacy of Powder Compositions Against American Cockroaches

The objective of this study was to evaluate the effectiveness of the 101-079 and 101-077 bait (0.6% S-Indoxacarb) against American cockroaches (Periplaneta americana) and Oriental cockroaches (Blattella orientalis) under laboratory conditions. The test method was as described above for Examples 4 and 5.

| | | | EPA Reg. | | |
|---|---|---|---|---|---|
| | | Active | No. and/or | Lot and/or | Snell Receipt |
| # | Test Substance | Ingredients | Est. No. | Batch # | Code |
| 1 | Controls-Untreated | N/A | N/A | N/A | N/A |
| 2 | Formula Code: 101-077 | 0.6% | N/A | N/A | 062617-1-C- |
| | | S-Indoxacarb | | | DHN |
| 3 | Formula Code: 101-079 | 0.6% | N/A | N/A | 062617-2-C- |
| | | S-Indoxacarb | | | DHN |
| 4 | Avert ® DF Dry | 0.050% | EPA Reg. | N/A | 013017-1-C- |
| | Flowable Cockroach | Abamectin B1 | No. 499-294 | | SNE |
| | Bait | | | | |

| | Test | | | |
|---|---|---|---|---|
| Trial | System | Strain | Stage/Age | Source |
| PERIAM | American | Lab | 80% Nymphs, | Purchased/ |
| | Cockroach | | 10% Males, | Lab Reared |
| | (Periplaneta | | 10% Non-Gravid | |
| | americana) | | Females | |
| BLTTOR | Oriental | Lab | 80% Mixed Nymphs, | Purchased/ |
| | Cockroach | | 10% Adult Males, | Lab Reared |
| | (Blattella | | 10% Non-Gravid | |
| | orientalis) | | Adult Females | |

The number of replicates conducted per test substance and the number of test systems evaluated per replicate were as follows for each trial:

| | | # Systems | | | |
|---|---|---|---|---|---|
| # Reps per | # Systems | per | # Test | Total # | # Test |
| Substance | per Rep | Substance | Substances | Systems | Arenas |
| 5 | 10 | 50 | 4 | 200 | 20 |

### RESULTS/DISCUSSION

The results of this study are shown in Table 8, which illustrates the mortality rates of the American (Periplaneta americana) and Oriental cockroaches (Blattella orientalis) at each observation interval after bait exposure. In addition to the percent mortality that is shown in the table, the mortality rates that were recorded were statistically analyzed using a t test with a probability value of p≤0.05 to evaluate if any significant differences were recorded between the control population and/or between the populations that were offered the bait formulations.

The 101-079 and 101-077 experimental baits performed similarly to each other during each species evaluation. Both experimental S-Indoxacarb baits (101-079 and 101-077) recorded 100% mortality during the American cockroach (PERIAM) and Oriental cockroach (BLTTOR) trials, and no significant difference in mortality was recorded between the two formulations. The Avert® DF bait (0.05% Abamectin) recorded the highest mortality within the shortest time-period with each species, and it performed significantly better than the two experimental baits during the early days after exposure (2-4 days).

### CONCLUSION

The results of the study prove that the 101-079 and 101-077 experimental baits are equally effective against American (Periplaneta americana) and Oriental cockroaches (Blattella orientalis), and that each formulation provides slower kill than the Avert® DF bait.

TABLE 8
% Mortality of Pests

| | | Pre- | 24 | Days After Treatment | | | | | | | | | |
|---|---|---|---|---|---|---|---|---|---|---|---|---|---|
| Trial | Test Substance: | trt | hr | 2 | 3 | 4 | 5 | 6 | 7 | 8 | 9 | 10 | 11 |
| PERIAM | Controls-Untreated | 0% | 0% | 0% | 0% | 0% | 0% | 0% | 0% | | | | |
| | 101-079 | 0% | 0% | 0% | 18% | 72% | 90% | 98% | 100% | | | | |
| | 101-077 | 0% | 0% | 0% | 22% | 64% | 80% | 98% | 100% | | | | |
| | Avert ® DF | 0% | 0% | 48% | 78% | 94% | 98% | 100% | 100% | | | | |
| BLTTOR | Controls-Untreated | 0% | 0% | 0% | 0% | 0% | 0% | 0% | 0% | 0% | 0% | 0% | 0% |
| | 101-079 | 0% | 2% | 16% | 36% | 66% | 78% | 84% | 92% | 94% | 96% | 98% | 100% |
| | 101-077 | 0% | 2% | 16% | 40% | 62% | 78% | 94% | 100% | 100% | 100% | 100% | 100% |
| | Avert ® DF | 0% | 4% | 68% | 98% | 100% | 100% | 100% | 100% | 100% | 100% | 100% | 100% |

### Example 7. Laboratory Evaluation of Control Solutions Insecticidal Dust Bait on Several Cockroach Pests

OBJECTIVE: The purpose of this study was to evaluate the efficacy of Control Solutions Inc. (CSI) dust powder bait formulations on several cockroach species (Periplaneta americana, Blattella germanica, and Blatta orientalis) compared to an industry standard in a laboratory trial.

PROCEDURE: A lab study was initiated by personnel from the Rollins Urban and Structural Entomology Facility at Texas A&M University in College Station, TX. Laboratory stocks of adult American cockroaches (Periplaneta americana), German cockroaches (Blatella germanica), and Oriental cockroaches (Blatta orientalis) were utilized in this study. Arenas consisted of 29×15 cm plastic boxes with the interior wall coated with Fluon® to prevent cockroach escape, and contained a source of harborage, food, and water. Cockroaches were allowed to acclimate to the test arena for 72 hours before the trial began. Each treatment was replicated 7 times and each replication received 10 adult cockroaches (no gravid females were used). After the acclimation period, one weigh boat with the powder bait treatment and a second weigh boat with a laboratory diet were introduced to the arenas. Both the insecticidal baits and laboratory diet were weighed before and after introduction to the arenas to measure the total amount consumed (g). Additionally, known weights of 7 replications of each bait and lab diet were placed in an empty plastic box, void of cockroaches, to correct for water gain/loss due to environmental conditions. Mortality counts were recorded daily for 14 days after bait exposure. All data were analyzed using SAS JMP Pro 13. The mortality over time and consumption data for all species were analyzed using an ANOVA with Tukey's. Due to each treatment receiving different quantities of bait, the consumption data is presented as the percentage of available bait consumed.

TABLE 9
The treatments used in this study.

| | | | Treatment |
|---|---|---|---|
| Treatments | Active Ingredient | Lab Code/Formula | Amount |
| DOXEM | 0.60% Indoxacarb | 103-059/106-043 | 0.050 g |
| DOXEM | 0.60% Indoxacarb | 103-059/106-043 | 0.075 g |
| DOXEM | 0.60% Indoxacarb | 103-059/106-043 | 0.150 g |
| AVERT DF | 0.05% Abamectin | N/A | 0.150 g |
| Control | N/A | N/A | N/A |

### AMERICAN COCKROACH

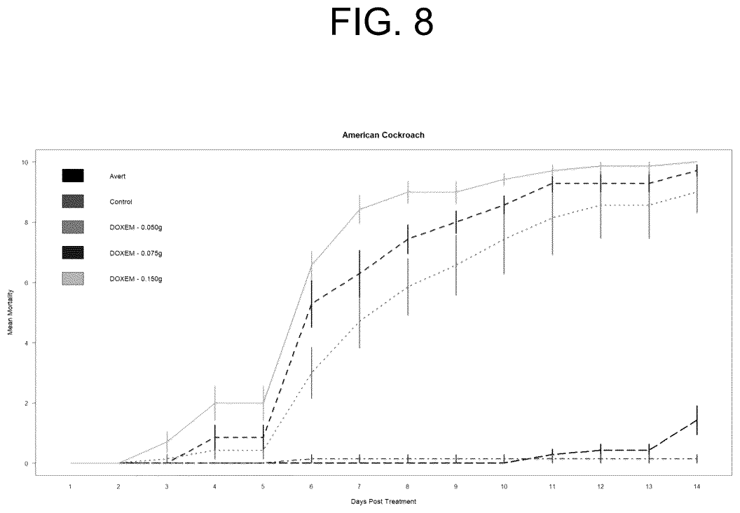

A summary of the mean mortality over time for American cockroaches can be found in Table 10 and visualized in FIG. 8. There was no mortality observed in any replication for the first two days after baits were introduced. From days 3-5, Doxem 0.15 was the only treatment with significantly higher mortality than the untreated control. The mean mortality in all of the Doxem replications was significantly higher than the untreated controls and Avert starting on day 6 through the end of the trial. Until day 10, the mean mortality in the Doxem 0.15 replications was significantly higher than the Doxem 0.05 replications. Greater than 95.0% mortality was achieved with Doxem 0.075 and 0.15. The mean mortality in the Avert replications was never significantly different from the untreated control.

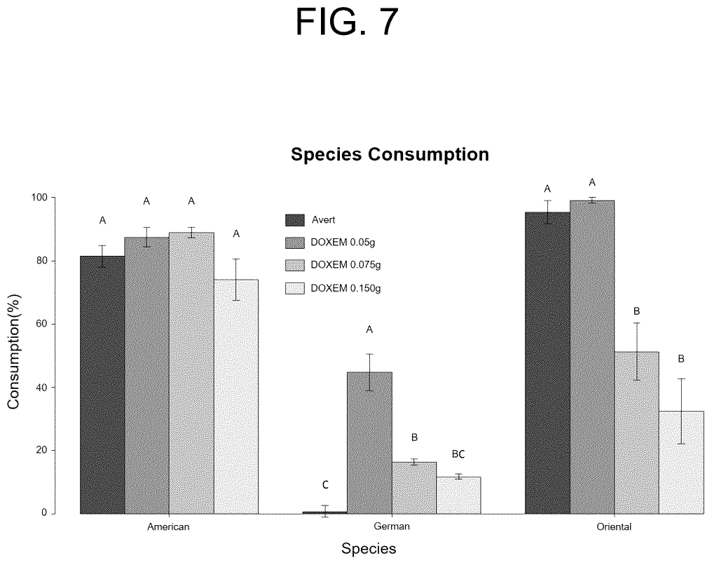

The mean percentage of bait consumed was not significantly different between treatments, with roughly 80.0-90.0% consumption across all treatments (FIG. 7). There was very little variation in the amount of laboratory diet consumed between treatments (Table 13) ranging from 0.353-0.457 g.

Significant control of American roaches was achieved starting about day 6 using both Doxem 0.075 and Doxem 0.15, whereas using Avert, the mean mortality rates were never significantly higher than the control. Their large sizes more than likely played a role as to how slow acting (compared to the other species) these baits were. There was a 2-3-day lag between when mortality started to increase in the Doxem 0.05 replications as compared to the other two Doxem treatments. This may be due to the fact that a single cockroach would sometimes dominate the bait and consume a majority of the 0.05 g offered to them. In this case, the other cockroaches would have received a lower dose, or that there was feeding on the carcass of the original cockroach and there was secondary kill from cannibalism.

In general, American cockroaches consumed more bait and laboratory diet than the other two species. As they are substantially larger species, this is what would be expected. There was no clear preference for one bait over another. Across all treatments the average consumption rate was 80.0-90.0% of the bait offered to them (FIG. 7).

### ORIENTAL COCKROACH

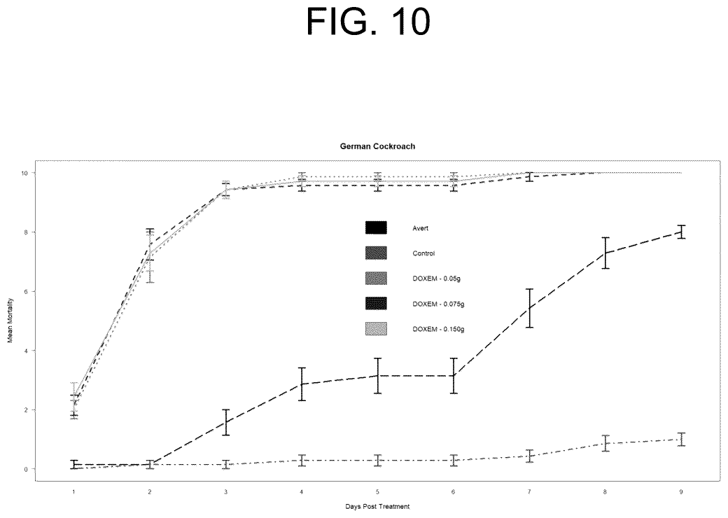

A summary of the mean mortality over time for Oriental cockroaches can be found in Table 11 and visualized in FIG. 10. No mortality was observed 1 day after baits were introduced. The mean mortality was significantly higher than the untreated control on day 2 in the Doxem 0.15 replications, day 3 in the Doxem 0.075 replications, and day 4 in the Doxem 0.05 replications. After day 3, there was no significant difference in the mean mortality between the Doxem treatments. The mean mortality in all of the Doxem treatments remained significantly higher than both the control and Avert replications until the end of the trial. Greater than 95.0% mortality was achieved using all Doxem treatments 11 days after the baits were introduced. The mean mortality in the Avert replications was significantly higher than the controls after day 9, but only reached a 33.0% mean mortality rate.

The mean percent of bait consumed in the Avert and Doxem 0.05 replications was significantly higher than the other two Doxem replications (FIG. 7). Like in the American cockroaches, the mean amount of lab diet consumed was similar across treatments (Table 13), ranging from 0.300-0.451 g.

There was a very similar pattern of mortality in this species as was seen in the American cockroaches. However, significant control of the Oriental cockroaches started much earlier, around day 3. Again there is a mortality lag (though not significant in this case) using Doxem 0.05 compared to the other two Doxem treatments. A separated study would help to parse out if this is a dosage problem, or if there is indeed secondary kill through cannibalism. The mean mortality in the Avert replication was significantly higher when used to control Oriental cockroaches as it was against American cockroaches, though after 14 days, only 33.0% mortality was achieved.

Of the amount of bait introduced to the arenas, more Avert and Doxem 0.05 was consumed than Doxem 0.075 and 0.15 (FIG. 7). The actual amount of bait consumed between Doxem treatments was similar, approximately 0.04-0.05 g (Table 13). The actual amount of Avert consumed was much higher (0.143), but the mortality over time observed in these replications was considerably lower and therefore the cockroaches had a longer period of time to feed.

### GERMAN COCKROACH

A summary of the mean mortality over time for Oriental cockroaches can be found in Table 12 and visualized in FIG. 10. The mean mortality in all of the Doxem replications was significantly higher starting 1 day after baits than the control and Avert replications. The mean mortality in across all Doxem replications was never significantly different from each other, and greater than 95.0% mortality was observed on day 4. The mean mortality in Avert replications was significantly higher than the control starting 3 days after baits were introduced. By the end of the trial, the Avert replications were at 80.0% mortality.

The mean percentage of Doxem 0.05 consumed was significantly higher than all other treatments (FIG. 7). Significantly less Avert was consumed than all other treatments, except Doxem 0.15. The percent consumption of Doxem 0.75 was not significantly different from Doxem 0.15 (FIG. 7). Less feeding on the laboratory diet was observed in all replications (Table 13), ranging from 0.001-0.077 g.

All of the Doxem baits were able to begin to control German cockroaches within 2 days and reached greater than 95.0% within 4 days. By the end of the trial, the mean mortality in the Avert replications was 80.0%, though significant control was not seen until day 7.

The proportion of bait consumed was statistically higher in the Doxem replications (FIG. 7), however like the Oriental cockroaches; the actual amount of bait consumed between these treatments was similar (Table 13). Very little avert was consumed (0.001 g), though enough that some mortality was still observed.

TABLE 10
American cockroach mortality over time. Numbers followed by different letters were significantly different
(ANOVA with Tukey’s, p < 0.05).

| Treatment | Day 1 | Day 2 | Day 3 | Day 4 | Day 5 | Day 6 | Day 7 | Day 8 | Day 9 | Day 10 | Day 11 | Day 12 | Day 13 | Day 14 |
|---|---|---|---|---|---|---|---|---|---|---|---|---|---|---|
| Doxem 0.15 | 0.0 | 0.0 | 0.7 ^{a} | 2.0 ^{a} | 2.0 ^{a} | 6.6 ^{a} | 8.4 ^{a} | 9.0 ^{a} | 9.0 ^{a} | 9.4 ^{a} | 9.7 ^{a} | 9.9 ^{a} | 9.9 ^{a} | 10.0 ^{a} |
| Doxem 0.075 | 0.0 | 0.0 | 0.0 ^{b} | 0.9 ^{ab} | 0.9 ^{ab} | 5.3 ^{ab} | 6.3 ^{ab} | 7.4 ^{ab} | 8.0 ^{ab} | 8.6 ^{a} | 9.3 ^{a} | 9.3 ^{a} | 9.3 ^{a} | 9.7 ^{a} |
| Doxem 0.05 | 0.0 | 0.0 | 0.1 ^{ab} | 0.4 ^{b} | 0.4 ^{b} | 3.0 ^{b} | 4.7 ^{b} | 5.9 ^{b} | 6.6 ^{b} | 7.4 ^{a} | 8.1 ^{a} | 8.6 ^{a} | 8.6 ^{a} | 9.0 ^{a} |
| Avert 0.15 | 0.0 | 0.0 | 0.0 ^{b} | 0.0 ^{b} | 0.0 ^{b} | 0.0 ^{c} | 0.0 ^{c} | 0.0 ^{c} | 0.0 ^{c} | 0.0 ^{b} | 0.3 ^{b} | 0.4 ^{b} | 0.4 ^{b} | 1.4 ^{b} |
| Control | 0.0 | 0.0 | 0.0 ^{b} | 0.0 ^{b} | 0.0 ^{b} | 0.1 ^{c} | 0.1 ^{c} | 0.1 ^{c} | 0.1 ^{c} | 0.1 ^{b} | 0.1 ^{b} | 0.1 ^{b} | 0.1 ^{b} | 0.1 ^{b} |

TABLE 11
Oriental cockroach mortality overtime. Numbers followed by different letters were significantly different
(ANOVA with Tukey’s, p < 0.05).

| Treatment | Day 1 | Day 2 | Day 3 | Day 4 | Day 5 | Day 6 | Day 7 | Day 8 | Day 9 | Day 10 | Day 11 | Day 12 | Day 13 | Day 14 |
|---|---|---|---|---|---|---|---|---|---|---|---|---|---|---|
| Doxem 0.15 | 0.0 | 2.3 ^{a} | 4.1 ^{a} | 6.1 ^{a} | 7.4 ^{a} | 7.9 ^{a} | 8.1 ^{a} | 9.0 ^{a} | 9.3 ^{a} | 9.4 ^{a} | 9.6 ^{a} | 9.6 ^{a} | 9.7 ^{a} | 9.7 ^{a} a |
| Doxem 0.075 | 0.0 | 1.1 ^{ab} | 4.6 ^{a} | 6.9 ^{a} | 8.6 ^{a} | 9.0 ^{a} | 9.1 ^{a} | 9.3 ^{a} | 9.6 ^{a} | 9.7 ^{a} | 9.9 ^{a} | 10.0 ^{a} | 10.0 ^{a} | 10.0 ^{a} |
| Doxem 0.05 | 0.0 | 1.0 ^{ab} | 4.6 ^{a} | 6.9 ^{a} | 8.6 ^{a} | 9.0 ^{a} | 9.1 ^{a} | 8.9 ^{a} | 9.0 ^{a} | 9.3 ^{a} | 9.6 ^{a} | 9.6 ^{a} | 9.7 ^{a} | 9.9 a |
| Avert 0.15 | 0.0 | 0.0 ^{b} | 0.0 ^{b} | 0.3 ^{b} | 0.3 ^{b} | 0.4 ^{b} | 0.6 ^{b} | 1.1 ^{b} | 1.9 ^{b} | 2.3 ^{b} | 2.7 ^{b} | 2.7 ^{b} | 3.1 ^{b} | 3.3 ^{b} |
| Control | 0.0 | 0.0 ^{b} | 0.0 ^{b} | 0.0 ^{b} | 0.0 ^{b} | 0.0 ^{b} | 0.0 ^{b} | 0.0 ^{b} | 0.0 ^{c} | 0.0 ^{c} | 0.0 ^{c} | 0.1 ^{c} | 0.1 ^{c} | 0.7 ^{c} |

TABLE 12
German cockroach mortality over time. Numbers followed by different letters
were significantly different (ANOVA with Tukey’s, p < 0.05).

| Treatment | Day 1 | Day 2 | Day 3 | Day 4 | Day 5 | Day 6 | Day 7 | Day 8 | Day 9 |
|---|---|---|---|---|---|---|---|---|---|
| Doxem 0.15 | 2.4 ^{a} | 7.3 ^{a} | 9.4 ^{a} | 9.7 ^{a} | 9.7 ^{a} | 9.7^{a} | 10.0 ^{a} | 10.0 ^{a} | 10.0 ^{a} |
| Doxem 0.075 | 2.1^{a} | 7.6^{a} | 9.4^{a} | 9.6^{a} | 9.6^{a} | 9.6^{a} | 9.9 ^{a} | 10.0 ^{a} | 10.0 ^{a} |
| Doxem 0.05 | 2.0 ^{a} | 7.1^{a} | 9.4^{a} | 9.9^{a} | 9.9^{a} | 9.9^{a} | 10.0 ^{a} | 10.0 ^{a} | 10.0 ^{a} |
| Avert 0.15 | 0.1 ^{b} | 0.1 ^{b} | 1.6 ^{b} | 2.9 ^{b} | 3.1 ^{b} | 3.1 ^{b} | 5.4^{b} | 7.3 ^{b} | 8.0 ^{b} |
| Control | 0.0 ^{b} | 0.1 ^{b} | 0.1 ^{c} | 0.3 ^{c} | 0.3 ^{c} | 0.3 ^{c} | 0.4^{c} | 0.9 ^{c} | 1.0 ^{c} |

TABLE 13
The mean amount (g) of bait and laboratory diet consumed by each species.

| | American | | German | | Oriental | |
|---|---|---|---|---|---|---|
| Treatment | Bait (g) | Lab diet (g) | Bait (g) | Lab diet (g) | Bait (g) | Lab diet (g) |
| Avert 0.15 | 0.122 | 0.353 | 0.001 | 0.001 | 0.143 | 0.354 |
| Doxem 0.05 | 0.047 | 0.454 | 0.022 | 0.012 | 0.050 | 0.390 |
| Doxem 0.075 | 0.068 | 0.411 | 0.013 | 0.001 | 0.039 | 0.371 |
| Doxem 0.15 | 0.113 | 0.421 | 0.018 | 0.010 | 0.049 | 0.300 |
| Control | N/A | 0.457 | N/A | 0.077 | N/A | 0.451 |

### Example 8. Laboratory Evaluation of Powder Compositions after a Wetting Event in a Choice Test on Two Cockroach Species

The objective of this study was to evaluate the efficacy of the test material, after wetting and drying, against two cockroach species, compared to negative controls, in a choice test. This was a laboratory efficacy study comparing a single application of the lowest label rate of the test material to a negative control. Following test material application, daily (repeated) observations were made on the experimental units for 14 days.

| | | Target | No. | | No. of |
|---|---|---|---|---|---|
| Cockroach | | Application | of | No. Bait | specimens/ |
| Species | Treatment | Rate | Reps | Placements | rep |
| American | Doxem | 0.05 g | 7 | 2 | 10 |
| | Precise | N/A | 7 | N/A | 10 |
| | Untreated | | | | |
| | Control | | | | |
| German | Doxem | 0.05 g | 7 | 1 | 10 |
| | Precise | N/A | 7 | N/A | 10 |
| | Untreated | | | | |
| | Control | | | | |

### Randomization

For each species, 14 random numbers (generated using Microsoft EXCEL) were assigned to the 14 (2 treatments×7 replicates/treatment) replicates. These numbers were sorted from smallest to largest to randomly order the replicates of the two treatments (see RANDOMIZATION form). Arena numbers (1-14) were entered in ascending order into this form to randomly assign the arenas to treatments.

An additional twenty-one (21) random numbers (generated using Microsoft EXCEL) were assigned to 21 weigh boats (7 to be used in the German replicates and 14 to be used in the American replicates). These numbers were sorted from smallest to largest to randomly order the replicates of the two groups (see RANDOMIZATION form). Weigh boat numbers (1-21) were entered in ascending order into this form to randomly assign the weigh boats to treatment arenas.

### Blinding/Masking Procedures

Due to a limited number of study personnel and a single treatment, blinding was not possible for this study. Study personnel remained unmasked for the duration of the study.

| Identity | Doxem ® Precise |
|---|---|
| Active ingredient(s) & concentration(s) | 0.6% Indoxacarb |
| Formulation | Dry Flowable Bait |
| EPA Reg. No. | 53883-438 |
| Packaging | 5 g cartridge |
| Name & address of manufacturer | Control Solutions, Inc. |
| | Pasadena, TX 77507 |
| Lot number | 19030261 |

| Common | Scientific | | | |
|---|---|---|---|---|
| Name | Name | Source/Strain | Life Stage | Notes |
| German | Blattella | Test Facility | Adults, | Non- |
| cockroaches | germanica | Lab Colonies | Mixed | Gravid |
| American | Periplaneta | | Sex (1:1) | Females |
| cockroaches | americana | | | |

### MATERIALS AND METHODS

### Cockroach Rearing

All cockroaches were obtained from test Facility colonies. Colonies were housed in 80 qt. plastic storage bins containing cardboard egg cartons for harborage. Colonies were fed a diet of Purina ONE® SmartBlend® dog food twice weekly, provided water ad libitum, and maintained at 27° C. (±1° C.), 40% (±10%) RH, and a 12:12 day/night light cycle.

### Preparation of Test Arenas

Seven arenas (replicates) of ten cockroaches were used for each test material and its respective control, for a total of 14 arenas per species. American cockroaches were housed in 73.6×45 cm plastic boxes, and German cockroaches in 29×15 cm plastic boxes. Interior walls of all boxes were coated with Fluon® to prevent escape. All cockroaches were acclimated to the arenas for 24 hours prior to test material introductions and provided food, water, and cardboard tubing for harborage throughout the experiment. Food and water were inspected daily and replenished as needed.

### Bait Wetting, Drying and Application

The test material was applied into 21 numbered (1-21) plastic weigh boats at 0.05 g (±0.005 g) per boat. This is the lowest label rate (bait placement rate) for Doxem® Precise. The actual average application rates were 0.0503 g/boat and 0.0502 g/boat for American and German cockroaches, respectively.

Weigh boats were placed on a scale and zeroed out before bait was added. Then the test material was applied by hand and its weight recorded. After placement in each weigh boat, the test material was wetted with 2.5 mL of deionized water (enough to thoroughly wet the bait) using a plastic pipette, and then placed under a fume hood for 24 hours. The material was not agitated or stirred. The material was completely dry before being added to the test arenas.

### Efficacy Trial

After cockroaches were acclimated to the arenas, weigh boats with dried bait were placed into numbered arenas based on the RANDOMIZATION Form. One weigh boat was placed into each of the German cockroach arenas and two weigh boats were placed into the American cockroach arenas. Counts of dead cockroaches were performed daily, beginning on day 1 and continuing through day 14, except on days 12 & 13 (see section 16). Mortality was defined as an insect that does not move, even when poked or probed.

Cockroaches had unlimited access to food and water for the duration of the trial. Ambient testing conditions were 27° C. (±1° C.), 60% (±10%) RH, and a 12:12 day/night light cycle.

### ASSESSMENT OF EFFICACY

### Endpoints Measured and Recorded

Daily counts of dead cockroaches.

### Methods for Computing the Efficacy of the Test Materials

The efficacy of the test material against each species at each time point was calculated using the following formula:

$$\% Control = 100 \times \frac{\begin{matrix}Mean no . live roaches in control group - \\ Mean no . live roaches in treated group\end{matrix}}{Mean no . live roaches in control group}$$

### STATISTICAL ANALYSES

Statistical analyses were performed by the Sponsor using Minitab 20.1 (Minitab, LLC, State College, PA). The experimental unit was the individual test arena. The dependent variable was the daily dead cockroach counts. Data for each cockroach species were analyzed separately.

General linear mixed effect models were used to perform repeated measure analyses of variance. The terms in each model were treatment (TRT), day (TIME), the interaction between treatment and day (TRT×TIME) and arena (random, nested in treatment).

The TRT×TIME interactions were significant (p<0.001), so the treatment groups were compared at each time point. These comparisons were obtained from the TRT×TIME interaction.

### RESULTS & DISCUSSION

The difference in mean numbers of dead German cockroaches between the treatment and control significant (p<0.05) beginning on SD 2 and continuing through SD 14 (Table 15). A single 0.05 g placement of Doxem Precise that had been wetted and dried controlled >90% of the German cockroaches in this study by SD 9.

The mean number of dead American cockroaches was significantly different (p<0.05) from controls beginning on SD 10 and continuing through SD 14 (Table 15). Two 0.05 g placements of Doxem Precise, that had been wetted and dried, failed to control 90% of the American cockroaches during this study.

### CONCLUSIONS

This study supports the following claims:

Wetted and dried Doxem Precise bait controls German cockroaches.

Wetted and dried Doxem Precise bait starts killing German cockroaches within 48 hours or 2 days.

These data support no claims against American cockroaches.

### PROTOCOL AMENDMENTS AND DEVIATIONS

There was one protocol deviation. On study days 12 and 13, the area in which the test facility is located experienced an extreme winter weather storm, making travel to the test facility impossible. Consequently, observations were not made on these days. This deviation did not impact the study, data collected or outcome.

TABLE 15
Mean counts of dead German and American
cockroaches and percent mortality (corrected for the control).
For each day, BOLD means are significantly different
from the untreated control (p < 0.05).

| | | German Cockroaches | | American Cockroaches | |
|---|---|---|---|---|---|
| Day | Treatment | Mean | % Control | Mean | % Control |
| 1 | Control | 0.1 | 9% | 0.1 | 0% |
| | Doxem | 1 | | 0.1 | |
| 2 | Control | 0.1 | 20% | 0.1 | 3% |
| | Doxem | 2.1 | | 0.4 | |
| 3 | Control | 0.1 | 57% | 0.1 | 6% |
| | Doxem | 5.7 | | 0.7 | |
| 4 | Control | 0.1 | 63% | 0.1 | 9% |
| | Doxem | 6.3 | | 1 | |
| 5 | Control | 0.1 | 74% | 0.1 | 10% |
| | Doxem | 7.4 | | 1.1 | |
| 6 | Control | 0.3 | 79% | 0.1 | 12% |
| | Doxem | 8 | | 13. | |
| 7 | Control | 0.4 | 84% | 0.1 | 19% |
| | Doxem | 8.4 | | 2 | |
| 8 | Control | 0.4 | 85% | 0.3 | 22% |
| | Doxem | 8.6 | | 2.4 | |
| 9 | Control | 0.4 | 90% | 0.3 | 25% |
| | Doxem | 9 | | 2.7 | |
| 10 | Control | 0.4 | 93% | 0.3 | 29% |
| | Doxem | 9.3 | | 3.1 | |
| 11 | Control | 0.4 | 96% | 0.3 | 34% |
| | Doxem | 9.6 | | 3.6 | |
| 14 | Control | 0.7 | 99% | 0.6 | 40% |
| | Doxem | 9.9 | | 4.4 | |

1. A non-consumable pesticidal powder composition, the composition comprising:
a. one or more pesticidal ingredient;
b. one or more anticaking agent;
c. one or more environmentally mimicking agent; and
d. optionally one or more non-food attractant.

2. The composition of claim 1, wherein the anticaking agent is precipitated calcium carbonate, stearic acid, tricalcium phosphate, silica, or any combination thereof.

3. The composition of claim 1, wherein the anticaking agent is precipitated calcium carbonate.

4. The composition of claim 1, wherein the environmentally mimicking agent is attapulgite, bentonite, powdered chitin, powdered kaolin, silica, or any combination thereof.

5. The composition of claim 1, wherein ingredients of the composition are not consumable.

6. The composition of claim 1, wherein particles of the composition are about 125 μm or less in size.

7. The composition of claim 1, wherein the composition comprises a moisture content ranging from about 0.2% to about 5% w/w.

8. The composition of claim 1, wherein the pest is a termite.

9. The composition of claim 1, wherein the pest is a termite, the composition is electrostatically charged using a device operable to electrostatically charge the composition during application, and the device is operable for precise application into nesting, tunneling, and/or gathering structures of termites.

10. A non-consumable pesticidal powder composition, the composition comprising:
a. fipronil at a concentration ranging from about 0.3% to about 0.7% w/w;
b. precipitated calcium carbonate at a concentration ranging from about 0.8% to about 1.2% w/w;
c. 2-phenoxy ethanol at a concentration ranging from about 0.08% to about 0.12% w/w; and
d. corn grit at a concentration ranging from about 95% to about 99.9% w/w.

11. The composition of claim 10, wherein the corn grit is 100 mesh or less.

12. A non-consumable pesticidal powder composition, the composition comprising:
a. novaluron at a concentration ranging from about 0.15% to about 0.25% w/w;
b. precipitated calcium carbonate at a concentration ranging from about 0.8% to about 1.2% w/w;
c. 2-phenoxy ethanol at a concentration ranging from about 0.08% to about 0.12% w/w; and
d. corn grit at a concentration ranging from about 95% to about 99.9% w/w.

13. A non-consumable pesticidal powder composition, the composition comprising:
a. fipronil at a concentration ranging from about 0.08% to about 1.2% w/w;
b. imidacloprid at a concentration ranging from about 0.3% to about 0.7% w/w;
c. powdered cellulose at a concentration ranging from about 0.3% to about 0.7% w/w;
d. precipitated calcium carbonate at a concentration ranging from about 0.8% to about 1.2% w/w;
e. 2-phenoxy ethanol at a concentration ranging from about 0.08% to about 0.12% w/w; and
f. attapulgite at a concentration ranging from about 95% to about 99.9% w/w.

14. A non-consumable pesticidal powder composition, the composition comprising:
a. chlorfenapyr at a concentration ranging from about 0.4% to about 0.8% w/w;
b. tricalcium phosphate powder at a concentration ranging from about 0.8% to about 1.2% w/w;
c. 2-phenoxy ethanol at a concentration ranging from about 0.08% to about 0.12% w/w; and
d. corn grit at a concentration ranging from about 95% to about 99.9% w/w.

15. The composition of claim 14, wherein the corn grit is 100 mesh or less.

16. A non-consumable pesticidal powder composition, the composition comprising:
a. indoxacarb at a concentration ranging from about 0.7% to about 1% w/w;
b. novaluron at a concentration ranging from about 0.15% to about 0.25% w/w;
c. pyriproxyfen at a concentration ranging from about 0.15% to about 0.25% w/w;
d. ergosterol at a concentration ranging from about 0.08% to about 0.12% w/w;
e. stearic acid at a concentration ranging from about 1.5% to about 2.5% w/w;
f. bentonite at a concentration ranging from about 1.5% to about 2.5% w/w;
g. powdered chitin at a concentration ranging from about 8% to about 12% w/w; and
h. powdered kaolin at a concentration ranging from about 75% to about 90 w/w.

17. The composition of claim 16, wherein the bentonite, the powdered chitin, and the powdered kaolin are 100 mesh or less.

18. An electrostatically charged non-consumable composition, the composition comprising:
a. novaluron at a concentration ranging from about 0.15% to about 0.25% w/w;
b. precipitated calcium carbonate at a concentration ranging from about 0.8% to about 1.2% w/w;
c. 2-phenoxy ethanol at a concentration ranging from about 0.08% to about 0.12% w/w; and
d. corn grit at a concentration ranging from about 95% to about 99.9% w/w;
wherein the composition is electrostatically charged on application.

19. The composition of claim 18, wherein the corn grit is 100 mesh or less.

20. An electrostatically charged non-consumable composition, the composition comprising:
a. indoxacarb at a concentration ranging from about 0.7% to about 1% w/w;
b. novaluron at a concentration ranging from about 0.15% to about 0.25% w/w;
c. pyriproxyfen at a concentration ranging from about 0.15% to about 0.25% w/w;
d. fumed silica at a concentration ranging from about 0.8% to about 1.2% w/w; and
e. brewer's yeast at a concentration ranging from about 95% to about 99.9% w/w.
